(19) United States
(12) Patent Application Publication
(10) Pub. No.: US 2026/0299278 A1
(43) Pub. Date: Oct. 1, 2026

(54) SYSTEMS AND METHODS FOR AUTOMATED, "SELF-DRIVING" LABORATORY ANALYSIS OF BIOLOGICAL AND CHEMICAL SPECIMENS

(71) Applicant: Triton Bio, Inc., Syracuse, NY (US)

(72) Inventors: Lorenzo D'Amico, Syracuse, NY (US); Patrick Viste, Syracuse, NY (US); Aniket Andraskar, Syracuse, NY (US); Sayali Patil, Syracuse, NY (US); Advait Shukla, Syracuse, NY (US)

(21) Appl. No.: 19/629,062

(22) Filed: Mar. 26, 2026

Related U.S. Application Data
(60) Provisional application No. 63/779,377, filed on Mar. 28, 2025.

(51) Int. Cl. G02B 21/36; G01N 35/00; G02B 21/26; G06F 40/30; H04N 23/61

(52) U.S. Cl. CPC G02B 21/365; G01N 35/00584; G02B 21/26; H04N 23/61; G06F 40/30

(57) ABSTRACT

A self-driving laboratory system and associated methods for autonomous scientific experimentation are disclosed. The system integrates automated laboratory instrumentation, multi-modal sensors, and artificial intelligence models to design, execute, and iteratively optimize biological or chemical experiments. A computing platform receives research objectives, generates experimental protocols, and controls laboratory instruments to perform experimental procedures. Experimental data are collected from imaging systems, analytical instruments, and environmental sensors and are integrated using machine learning and sensor fusion techniques to estimate experimental state. Optimization algorithms, including probabilistic and multi-objective models, analyze the data to generate modified experimental protocols that improve experimental outcomes. The system may dynamically adjust environmental parameters and measurement strategies during experimentation and may share learning across distributed laboratory sites. Digital twin models may simulate laboratory workflows to guide experimental planning. The disclosed platform enables efficient exploration of complex experimental parameter spaces while improving reproducibility, resource utilization, and discovery in automated laboratory environments.

### CROSS REFERENCE TO RELATED APPLICATIONS

This application claims priority to and the benefit of prior filed U.S. Provisional Patent Application Ser. No. 63/779,377, filed Mar. 28, 2025 hereby incorporated by reference herein.

### FIELD OF THE INVENTION

The present invention relates to methods and systems for analyzing biological and chemical samples, and more particularly to a method and system for achieving automated control over environmental conditions (e.g., temperature, humidity, atmospheric gas composition, electromagnetic radiation levels, pressure) of biological specimens (e.g., solid cultures or liquid suspensions of bacteria, fungi, protozoa, parasites, cells, cell clusters, organoids, viral plaques, biochemical solutions, biomaterials, biofunctionalized microbeads, enzymatic solutions, multicellular organisms, plant matter, insects, animals), chemical specimens (e.g., chemical solutions, powders, solid substances, cosmetics, lotions, ointments), food and beverages samples, and a means of analysis over time of said specimens (e.g., electromagnetic reflectivity, absorptivity, transmittance, fluorescence, luminescence, phosphorescence) to achieve detection, quantitation of geometric features (e.g. size, shape), enumeration of objects and features, analysis of growth and decay, analysis of color, analysis of movement behavior (e.g., acceleration, velocity, displacement, direction), a provision for a means of transference of said specimens into other physical compartments and systems (e.g., automated colony pickers, liquid handling robots) for further manipulation and analysis, and methods for predicting outcomes or characteristics of said specimens based on statistical modeling and data classification processes that use both operator text, audio, gesture and spoken inputs in combination with computing methods.

The present disclosure relates generally to automated laboratory systems, artificial intelligence-driven experimentation platforms, and distributed scientific computing infrastructures. More particularly, the disclosure relates to systems and methods that integrate machine learning models, robotic laboratory instrumentation, multi-modal sensor networks, and real-time computational analysis to enable partially or fully autonomous biological experimentation.

In certain embodiments, the disclosed technology provides a self-driving laboratory platform capable of designing experiments, executing experimental protocols, analyzing experimental outcomes, and iteratively optimizing experimental parameters with minimal human intervention. Such systems may be applied to fields including biotechnology, pharmaceutical discovery, microbiology, agricultural sciences, food safety testing, chemical engineering, and materials discovery.

### BACKGROUND OF THE INVENTION

Modern biological experimentation often involves highly complex systems characterized by numerous interacting variables. For example, experiments involving microbial cultures, mammalian cell lines, enzyme expression, or biochemical synthesis may depend on factors including temperature, pH levels, nutrient composition, oxygen concentration, induction timing, reagent concentrations, genetic constructs, and environmental conditions.

Traditional laboratory experimentation typically relies on human-designed protocols and sequential testing of experimental parameters. Researchers commonly select a limited number of experimental conditions based on prior experience or literature references. Experiments are then conducted manually or using partially automated laboratory instruments, after which the resulting data are analyzed retrospectively.

Although laboratory automation technologies have advanced significantly, most existing automated systems remain limited in scope. For example, liquid handling robots, automated incubators, plate readers, and imaging systems can perform repetitive tasks with high precision, but these devices generally execute predefined protocols and lack the ability to autonomously design or modify experiments based on emerging results.

Existing automated experimentation platforms also frequently treat experimental design, data acquisition, and data analysis as separate processes. Data collected from laboratory instruments may be stored in laboratory information management systems (LIMS) or analyzed using independent software tools, but the insights generated from such analysis are typically applied manually by human researchers in subsequent experimental iterations.

Another limitation of current laboratory automation systems is the difficulty of efficiently exploring large experimental parameter spaces. Biological systems often exhibit nonlinear responses to environmental conditions, meaning that small changes in parameters may lead to significant differences in experimental outcomes. Exhaustive testing of all possible parameter combinations quickly becomes impractical due to resource limitations, experimental costs, and time constraints.

Furthermore, modern biological experiments generate large volumes of heterogeneous data, including microscopy images, spectral measurements, sensor readings, biochemical assay results, and time-series observations. Conventional analysis methods frequently evaluate these data streams independently, making it difficult to identify complex relationships between experimental variables and biological responses.

Reproducibility across different laboratories represents another challenge. Differences in equipment configurations, environmental conditions, operator practices, and data analysis methods can result in inconsistent experimental outcomes even when nominally identical protocols are followed.

Previous attempts to automate biological specimen analysis and control processes have resulted in complex and costly systems with significant limitations. Analysis of key prior art reveals several technological gaps:

Automation and Hardware Systems

U.S. Pat. No. 7,122,158(2006 ) disclosed a computerized incubator apparatus utilizing complex XY gantry systems for sample positioning and imaging.

U.S. Pat. No. 6,673,532(2004 ) presented bioprocessing techniques requiring sophisticated robotic implementations.

U.S. Pat. No. 8,092,695(2012 ) “Automated colony picking apparatus” focused solely on colony selection without addressing broader workflow integration.

While these systems achieved basic automation, their complexity and cost limited widespread adoption, particularly in low-to medium-throughput laboratories.

Environmental Control Systems

U.S. Pat. No. 8,865,473(2014 ) introduced modular high-throughput systems.

U.S. Pat. No. 9,434,937(2016 ) described controlled cultivation methods.

These systems, while effective for large scale operations, relied on complex mechanical systems and elaborate control mechanisms that proved cost prohibitive for many research facilities.

Data Integration and Analysis Systems

U.S. Pat. No. 9,240,043(2016 ) “Systems and methods for automated biological sample analysis” addressed some aspects of automation but failed to provide comprehensive integration of multi-modal data.

U.S. Pat. No. 7,865,008(2011 ) “Methods and systems for biological sample handling” limited its scope to sample handling without considering data integration needs.

These existing patents and their implementations collectively fail to address several fundamental needs:
a. Integration of multiple data sources while maintaining system simplicity;
b. Provision of real-time analysis capabilities at reasonable cost;
c. Cost-effective solutions suitable for small to medium laboratories;
d. Natural interaction methods that simplify operation; and
e. Predictive analysis capabilities that leverage accumulated data.

The complexity and cost of these prior systems have created significant barriers to adoption, particularly for smaller research facilities and laboratories with moderate throughput requirements. Furthermore, none of these systems successfully addresses the crucial need for integrated data analysis and prediction capabilities while maintaining operational simplicity.

The present invention describes a set of systems that overcome historical engineering challenges and make it possible to achieve cost-effective and automated control over environmental conditions and motion of biochemical specimens while simultaneously capturing digital image and video data of said specimens. The modular design and mechanisms of motion and system controls described herein provide a means for scaling for low-and very-high throughput analytical requirements.

Accordingly, there exists a need for improved laboratory automation systems capable of integrating experimental design, experimental execution, data analysis, and iterative optimization within a unified computational framework. Such systems should be capable of interpreting experimental objectives, generating candidate experimental protocols, executing those protocols using automated instrumentation, analyzing resulting data in real time, and refining future experiments based on observed outcomes.

### SUMMARY OF THE INVENTION

The present disclosure addresses the limitations of existing laboratory automation systems by providing an integrated self-driving laboratory platform that combines artificial intelligence, robotic laboratory instrumentation, multi-modal sensor systems, and distributed computing infrastructure.

In certain embodiments, the disclosed system forms a closed-loop experimental platform capable of:
1. Translating research objectives into executable experimental protocols;
2. Executing experimental procedures using automated laboratory instrumentation;
3. Collecting and analyzing experimental data in real time;
4. Dynamically modifying experimental parameters based on observed outcomes; and
5. Iteratively improving experimental strategies through machine learning.

In one embodiment, artificial intelligence models interpret experimental objectives expressed in natural language or structured input formats. These models extract relevant experimental variables and generate candidate experimental protocols for testing hypotheses regarding relationships between experimental conditions and biological outcomes.

The generated experimental protocols may then be executed using coordinated laboratory automation systems including liquid handling robots, environmental control systems, analytical instruments, and imaging devices. Data collected from these instruments may include optical imaging, spectroscopic measurements, metabolic indicators, environmental sensor readings, and biochemical assay results.

Machine learning models may analyze these data streams in real time to estimate the current experimental state and identify emerging trends or deviations from expected behavior. Based on these analyses, the system may adjust experimental parameters dynamically or propose new experiments to improve performance relative to predefined objectives.

In some embodiments, the system may further incorporate distributed learning capabilities enabling multiple laboratory sites to share experimental insights, optimization strategies, and analytical models. Such capabilities may accelerate experimental discovery while improving reproducibility across different facilities.

Through these mechanisms, the disclosed platform enables autonomous or semi-autonomous experimentation capable of exploring large experimental parameter spaces efficiently while maintaining rigorous quality control.

AI-Based Experimental Planning. In certain embodiments, experimental planning is performed by artificial intelligence models trained to interpret research objectives and translate them into executable experimental protocols.

Such models may include natural language processing systems trained on scientific literature, laboratory protocols, and experimental databases. When provided with a research objective, the system may identify relevant biological systems, environmental parameters, measurement techniques, and operational constraints.

For example, a research objective relating to optimization of enzyme expression in microbial hosts may involve variables including culture temperature, nutrient concentrations, induction timing, aeration levels, and host strain characteristics. The AI system may extract these parameters and generate candidate experimental conditions designed to explore their interactions.

The system may further incorporate knowledge from external databases including genomic repositories, protein structure databases, metabolic pathway libraries, and prior experimental records. These information sources may help constrain experimental designs to biologically plausible regions of parameter space.

Generated experimental protocols may include sets of candidate conditions selected to maximize information gain regarding relationships between experimental variables and desired outcomes.

Probabilistic Optimization of Experimental Conditions. To efficiently explore complex parameter spaces, the system may employ probabilistic optimization techniques such as Bayesian optimization. Such methods enable efficient identification of promising experimental conditions while minimizing the number of required experiments.

In one embodiment, Gaussian process models are used to estimate relationships between experimental parameters and observed outcomes. These models provide predictions of expected performance across parameter space while also estimating uncertainty associated with unexplored regions.

Acquisition functions may then be used to select new experimental conditions balancing exploitation of promising parameter regions with exploration of uncertain areas. As additional experimental data become available, the models are updated to refine predictions and guide further experimentation.

This iterative optimization process allows the system to rapidly identify high-performing experimental conditions without exhaustive search of the entire parameter space.

Multi-Objective Optimization. Biological experimentation frequently involves multiple competing objectives. For instance, researchers may seek to maximize production yield while minimizing cellular stress, reagent cost, or experimental duration.

In certain embodiments, the system therefore implements multi-objective optimization techniques capable of evaluating trade-offs between different performance metrics. Pareto optimization methods may be used to identify sets of experimental conditions that represent optimal compromises between competing objectives.

The resulting experimental strategies may therefore balance multiple factors simultaneously rather than focusing on a single optimization criterion.

Automated Experimental Execution. The disclosed system may coordinate multiple automated laboratory instruments to execute experimental protocols. Such instruments may include liquid handling robots, incubators, environmental control systems, spectroscopic analyzers, flow cytometers, plate readers, and imaging platforms.

A centralized orchestration framework may schedule instrument operations, coordinate sample transfers, and synchronize measurements to ensure that collected data correspond to consistent experimental states.

In certain embodiments, the system may monitor experimental progress continuously and detect deviations from expected trajectories. If abnormal conditions are detected, the system may modify experimental parameters or trigger additional measurements to investigate the underlying cause.

Computer Vision and Phenotypic Analysis. Visual observation of biological specimens represents an important source of experimental information. Accordingly, the system may incorporate computer vision techniques for analyzing microscopy images, colony growth patterns, cellular morphology, and fluorescence signals.

Machine learning models including convolutional neural networks or transformer-based vision architectures may be used to extract quantitative features describing biological structures and behaviors.

Extracted visual features may be integrated with other sensor measurements to provide a comprehensive representation of the biological system under investigation.

Multi-Modal Sensor Fusion. In some embodiments, the system integrates data from multiple measurement modalities including optical imaging, environmental sensors, spectroscopic instruments, and biochemical assays.

Sensor fusion algorithms may combine these heterogeneous measurements into a unified estimate of experimental state. For example, metabolic activity indicators may be correlated with imaging-derived morphological features and environmental measurements to determine the physiological state of a microbial culture.

This integrated state estimation may enable earlier detection of experimental deviations and more accurate prediction of experimental outcomes.

Adaptive Experimental Control. Using real-time data analysis and predictive models, the system may dynamically adjust experimental parameters during execution. Environmental conditions such as temperature, nutrient supply, aeration levels, and sampling intervals may be modified in response to observed biological behavior.

Adaptive imaging strategies may also be implemented, allowing the system to modify imaging frequency, exposure settings, or scanning regions to capture relevant biological events more effectively.

Distributed Learning Architecture. In certain embodiments, the platform may support distributed learning across multiple laboratory sites. Experimental results obtained at one facility may inform experimental planning at other facilities through shared analytical models and knowledge repositories.

Federated learning approaches may be used to enable collaborative model improvement while preserving site-specific data privacy requirements.

Digital Twin Simulation. The system may further include digital twin models representing laboratory workflows, instruments, and experimental processes. These models enable simulation of experimental procedures prior to physical execution.

Through such simulations, the system may identify potential workflow bottlenecks, evaluate resource requirements, and test alternative protocol configurations.

Advantages of the Disclosed System. The integrated architecture described herein provides numerous advantages relative to conventional laboratory automation systems.

First, the integration of AI-driven experimental planning with automated instrumentation enables efficient exploration of complex experimental spaces that would otherwise be impractical to investigate manually.

Second, real-time analysis and adaptive control allow experiments to evolve dynamically based on emerging data.

Third, distributed learning across laboratories accelerates discovery while improving experimental reproducibility.

Fourth, the combination of sensor fusion, computer vision, and probabilistic optimization enables earlier detection of promising experimental conditions and more efficient use of laboratory resources.

The systems and methods described herein establish a framework for autonomous or semi-autonomous laboratory experimentation. By integrating artificial intelligence, automated instrumentation, sensor fusion, and distributed computational infrastructure, the disclosed platform enables adaptive experimentation and accelerated scientific discovery.

Such self-driving laboratory systems represent a significant advancement in laboratory automation technology and provide a foundation for future research environments capable of continuous experimental learning and optimization.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of a system according to a preferred embodiment of the invention.

FIG. 2 is a side view of a system according to a preferred embodiment of the invention.

FIGS. 3A and 3B are perspective views of a light modulating assembly with lamp coupling and at bottom an elevation of a longitudinal view according to a preferred embodiment of the invention.

FIG. 3C is a side view of a light modulating assembly and lamp coupling according to a preferred embodiment of the invention.

FIG. 3D is a top plan view of a light modulating assembly and lamp coupling according to a preferred embodiment of the invention.

FIG. 4 is a plan view of a carousel tray according to a preferred embodiment of the invention.

FIG. 5 is a block diagram of the automated images analysis process of biological samples according to a preferred embodiment of the invention.

FIG. 6 is a flow chart of the process according to a preferred embodiment of the invention.

### DETAILED DESCRIPTIONS OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for later filed claims and as a representative basis for teaching one skilled in the art to employ the present invention in virtually any appropriately detailed system, structure or manner.

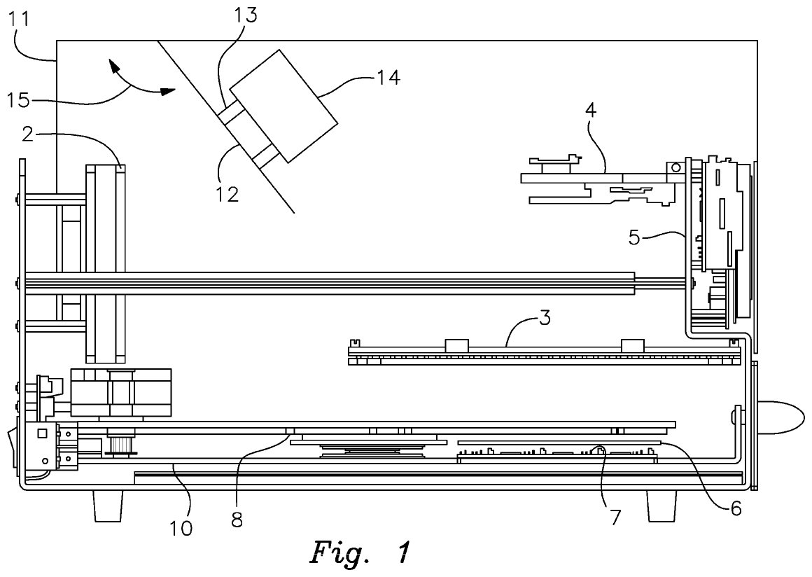

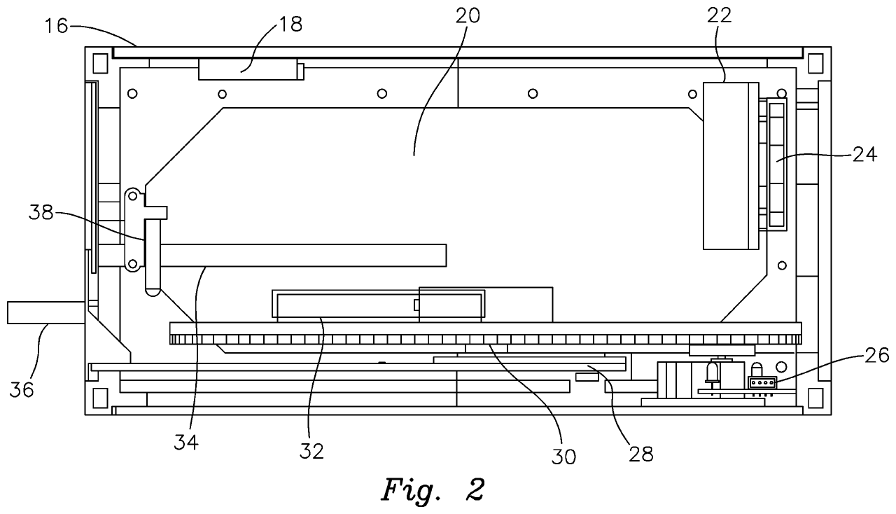

FIGS. 1 and 2 shows cross sectional views of the system of a preferred embodiment of the invention.

Referring to FIGS. 1 and 2, there is illustrate an integrated, adaptive biological imaging and environmental control system configured to perform controlled observation, monitoring, and analysis of biological specimens. The system combines coordinated subsystems in housing 11 including illumination control, thermal regulation, sample positioning, and image acquisition, which may operate in a closed-loop configuration to enable automated experimentation and analysis.

The system comprises a thermal control subsystem, an illumination subsystem, a sample positioning subsystem, and an image acquisition subsystem, all operatively coupled via control electronics 5. Control electronics 5 may include one or more processors, memory devices, and communication interfaces configured to coordinate operation of the subsystems and implement control logic.

In certain embodiments, control electronics 5 may execute software instructions that receive sensor inputs, including temperature measurements and image data, and generate control signals to dynamically adjust system parameters. This establishes a closed-loop control architecture in which system behavior is continuously refined based on observed biological conditions.

The thermal control subsystem includes heating system 2 and resistive heater or thermoelectric module 22 disposed within internal compartment 20 defined by enclosure 16. Heating system 2 and heater 22 are configured to regulate environmental conditions within the imaging chamber.

Temperature probe 38 is positioned to measure temperature within internal compartment 20 and provide feedback to control electronics 5. Control electronics 5 may adjust operation of heating system 2 based on measured temperature to maintain a target temperature setpoint or profile.

Fan 24 is configured to circulate air within internal compartment 20, thereby reducing thermal gradients and promoting uniform environmental conditions. In some embodiments, the thermal control subsystem may support programmable temperature profiles, including ramping, cycling, or multi-zone control.

The illumination subsystem includes diffusing ring illuminator 3, illuminator diffuser 6, diffusing sample stage base 8, and light modulating assembly 14. Printed Circuit Board 7 may contain a camera with miniaturized optics and illuminators to permit the taking of photographic images from below the samples. These components are configured to provide controlled illumination conditions for imaging biological specimens.

Diffusing ring illuminator 3 provides circumferential illumination of a sample region. Illuminator diffuser 6 and diffusing sample stage base 8 distribute illumination to minimize shadows and improve uniformity.

Light modulating assembly 14 is mounted on adjustable angle rails 12 via sliding mounts 13. Adjustable angle rails 12 enable angular positioning of light modulating assembly 14, as indicated by pivot direction 15. Sliding mounts 13 enable translational positioning along adjustable angle rails 12.

In some embodiments, light modulating assembly 14 may include optical filters, lenses, diffusers, or programmable light sources. Control electronics 5 may adjust illumination parameters including intensity, angle, wavelength, and spatial distribution based on imaging requirements.

The sample positioning subsystem includes sliding stage 10 configured to position samples within the imaging region. In FIG. 2, the subsystem further includes carousel gear 30 configured to rotate specimen vessel 32. Carousel gear 30 may be driven by motor coupled through a shafting mount plate 28. Position sensor 26 detects the position of specimen vessel 32 and provides feedback to control electronics 5. Control electronics 5 may synchronize sample positioning with image acquisition.

Specimen vessel 32 may include multiple sample holders, enabling high-throughput imaging of multiple biological samples. Handle 36 may facilitate insertion and removal of the sample assembly. The image acquisition subsystem includes image capture system and optical filter array 4 housed within camera housing 18. The image capture system 4 is configured to capture images of biological samples under controlled illumination conditions. Illuminator 34 may be employed to provide light for the samples.

The optical filter array enables selective imaging across different wavelength bands, supporting applications such as fluorescence imaging, spectral analysis, and feature detection. Image capture system 4 may include one or more imaging sensors, lenses, and optical components. In certain embodiments, the image acquisition subsystem may capture time-series image data representing biological changes over time. The captured data may be transmitted to control electronics 5 or external processing systems for analysis.

In operation, the system performs coordinated control of illumination, thermal conditions, sample positioning, and imaging. The thermal control subsystem establishes environmental conditions. The illumination subsystem provides controlled lighting. The sample positioning subsystem aligns samples for imaging. The image acquisition subsystem captures data representing biological states.

In certain embodiments, image data may be analyzed to extract biological features such as growth rates, morphological characteristics, or fluorescence signals. These features may be used by control electronics 5 to adjust system parameters.

For example, the control system may increase illumination intensity to enhance contrast, adjust temperature to influence biological growth, or modify sampling frequency based on observed changes. This establishes a closed-loop experimental system capable of adaptive operation.

In some embodiments, the system may implement methods including: positioning a biological sample, illuminating the sample under controlled conditions, capturing image data, analyzing the image data to extract features, and adjusting system parameters based on the extracted features.

In alternative embodiments, the illumination subsystem may include tunable filters, laser-based illumination, or adaptive optics. The thermal control subsystem may include fluid-based temperature regulation or distributed heating elements. The sample positioning subsystem may include robotic manipulators or microfluidic transport systems.

The image acquisition subsystem may include hyperspectral imaging, structured illumination, or high-resolution microscopy. The control system may incorporate machine learning models configured to optimize experimental conditions based on historical data. The particular arrangement of components shown in FIGS. 1 and 2 is illustrative and not limiting. Equivalent components and alternative configurations may be used to achieve

The system may be comprised of several sub-systems:

Physical Enclosure. The invention includes walls and framing hardware to provide a structural barrier to heat and mass transport, such that the conditions of the internal compartment like temperature, gas composition, light intensity, can be controlled.

A preferred embodiment of the invention includes a physical enclosure that serves as the primary containment and control structure for the system.

This enclosure comprises walls and framing hardware constructed to provide a robust structural barrier, includes gaskets positioned at the junctions of panels to minimize air and light leakage; materials selected to minimize heat and mass transport between internal compartment and external environment while also providing mechanical rigidity needed for shipping, design enabling precise control of temperature, gas composition, light intensity, humidity levels, and pressure conditions. A wall component physically attached to a rectangular plate at a right angle when the assembly (sample holder and rectangular plate) is fully inserted, the wall completes the enclosure. This design minimizes air and light exchange between the internal compartment and external environment.

Environmental Control Features. Specialized ports on the external framing allowing for gas exchange with other units or systems, removable water tray system at the bottom of the incubator for humidity control, strategic positioning of environmental sensors throughout the enclosure, thermal isolation features to maintain stable internal conditions include integration Points, which include access points for sample loading and unloading, ports for electrical and data connections, integration features for external automation systems; mounting points for internal subsystems including, which include temperature control components, imaging systems, sample handling mechanism, sensor arrays. Modular Design Elements allow for construction allowing for different scale implementations, adaptable mounting systems for various specimen vessel types, and configurable access points for different automation requirements.

Temperature regulation is provided for using heating and cooling within the internal compartment of the physical incubator enclosure may be accomplished in many ways. In the preferred embodiment, one or more modules contain at least one thermoelectric unit that is in physical contact with a heat spreader and in proximity to at least one fan or blower. The heat spreader is preferably a material with good thermal conductivity, such as metal, and is shaped with fins to maximize convective heat transport. The fan is oriented such that air is blown over the heat spreader component.

The heater subassembly is configured such that air is forced over the heat sinks and through narrow vents to facilitate mixing within the enclosure.
i. At least one temperature probe is positioned within the internal compartment to provide feedback to analog or digital temperature control systems.
ii. Condensation on the lid of petri dishes and similar vessels may be prevented or cleared by intentionally imposing a slight thermal gradient and by selecting specific materials and positioning the heater in a specific way. This is accomplished by positioning at least one temperature probe above the sample plane. By channeling air through vents, warmed air is distributed in a pattern to facilitate mixing but without creating a vertical gradient (perpendicular to the plane of the samples).
iii. A means for also cooling the internal compartment. A means for heating and cooling the internal compartment may also be accomplished using Peltier devices, which can generate heat or cold depending on the direction of the electric current. The thermoelectric units are attached to heat sinks with fans to dissipate the excess heat or cold to the external environment. The fan is also used to transport hot or cool air within the internal compartment so that specimens are incubated at the desired temperature. The temperature of the internal compartment is regulated by a feedback loop that controls the current direction and intensity of the thermoelectric units.

Humidity Monitoring and Control. Maintaining precise humidity control in laboratory incubation systems presents significant technical challenges that existing solutions have inadequately addressed. Prior systems, such as those described in U.S. Pat. No. 8,865,473(2014 ), typically rely on complex humidification systems involving ultrasonic generators or pressurized water vapor injection, which are both costly and prone to maintenance issues. The present invention introduces several innovative approaches to humidity control that overcome these limitations while providing superior flexibility and reliability.

Primary Humidity Generation Systems. The invention implements a fundamentally different approach to humidity generation and control. Unlike prior art systems that require complex mechanical components, our system utilizes passive and semi-passive methods that achieve precise humidity control while minimizing system complexity and maintenance requirements.
a. Base Water Reservoir System. The primary humidity generation mechanism comprises a removable water pan integrated into the base of the enclosure. This approach provides several advantages over existing systems:
   i. Simplified maintenance through easy access and cleaning;
   ii. Natural evaporation provides stable humidity levels without mechanical complexity;
   iii. Strategic positioning beneath the specimen area ensures uniform humidity distribution; and
   iv. Optional integration with the temperature control system enables enhanced evaporation control.
b. Auxiliary Humidity Sources. The system uniquely accommodates the placement of calibrated water vessels, addressing a limitation in existing incubation systems that typically offer only fixed humidity generation methods. This innovation provides several benefits:
   i. Enables precise local humidity control through strategic vessel placement;
   ii. Allows creation of controlled humidity gradients for experimental purposes;
   iii. Provides redundancy in humidity generation; and
   iv. Facilitates easy sterilization and maintenance.
c. Humidity Monitoring and Control. Current laboratory incubation systems often implement basic humidity monitoring with limited control capabilities. Our invention introduces a more sophisticated approach that enables precise humidity control while maintaining system simplicity.
   i. Sensor Integration. The system employs strategically positioned humidity sensors that provide:
      1. Real-time monitoring of relative humidity levels;
      2. Differential humidity sensing between multiple points; and
      3. Integration with temperature control feedback systems.
   ii. This multi-point sensing approach represents an advance over existing systems that typically rely on single-point measurements, enabling more precise humidity control and the ability to detect and correct spatial variations in humidity levels.
d. Novel Control Mechanisms. Unlike conventional systems that rely solely on electronic humidity control, our invention implements a hybrid approach combining passive and active control mechanisms. This innovative method provides:
   i. More stable humidity control through natural buffering;
   ii. Reduced energy consumption;
   iii. Lower maintenance requirements; and
   iv. Enhanced reliability through system redundancy.

Integration with Temperature Control. A key innovation of our system is the intimate integration between humidity and temperature control systems. Existing solutions typically treat these as separate parameters, leading to control conflicts and stability issues. Our approach:
a. Coordinates temperature and humidity control algorithms;
b. Prevents condensation through intelligent gradient management;
c. Maintains stable conditions even during temperature transitions; and
d. Enables creation of precise microenvironments for specialized applications.

This integrated approach represents a significant advance over prior art systems that handle temperature and humidity control independently, resulting in improved stability and more precise environmental control.

The system's ability to maintain precise humidity levels while minimizing complexity and maintenance requirements represents a significant advance over existing solutions. The combination of passive and active control elements, along with sophisticated monitoring and integration capabilities, provides unprecedented flexibility and reliability in laboratory environmental control applications.

Water Management Systems. The invention implements several innovative approaches to water level monitoring and replenishment, ensuring consistent humidity generation while maintaining system simplicity and reliability.
a. Automated Level Monitoring. The base water reservoir incorporates a sophisticated yet reliable level monitoring system. A primary sensor array utilizes capacitive level detection, with electrodes integrated into the reservoir walls, providing continuous non-contact measurement of water level without introducing contamination risks. This system enables:
   i. Real-time water level monitoring with 1 mm resolution;
   ii. Early warning notifications when water levels approach minimum thresholds;
   iii. Integration with the main control system for automated alerts; and
   iv. Historical tracking of water consumption rates.
b. For redundancy, an optical level detection system serves as a backup, utilizing an infrared emitter-detector pair that monitors the water surface position. This dual-sensor approach ensures reliable operation even if one system experiences interference or malfunction.

Water Replenishment Methods. The system supports both manual and automated water replenishment:
a. Manual Refill System. The removable water pan includes a transparent inspection window with clearly marked minimum and maximum fill lines. A specially designed fill port, accessible from the exterior of the enclosure, enables water addition without disturbing the environmental conditions or specimens. This port implements several key features:
   i. A self-sealing silicone membrane that prevents humidity escape during filling;
   ii. A funnel design that prevents spillage;
   iii. Clear volume indicators for precise manual filling; and
   iv. Optional sterile filter for water sterilization during filling.
b. Automated Refill Implementation. For applications requiring continuous unattended operation, the system can be equipped with an automated refill mechanism. This consists of:
   i. An external reservoir containing purified water;
ii. A precision peristaltic pump for controlled water addition;
   iii. Level sensors in both main and auxiliary reservoirs;
   iv. Automated valves for flow control; and
   v. Leak detection systems for safety.
c. The automated system maintains water levels within ±2mm of the target level, ensuring stable humidity generation while preventing overflow conditions.

Maintenance Considerations. The water management system is designed for easy maintenance and cleaning:
a. The primary reservoir can be removed without tools;
b. All surfaces are designed with appropriate slopes to prevent water pooling;
c. Materials are selected for chemical resistance and sterilization compatibility; and
d. Quick-disconnect fittings enable rapid reservoir exchange.

Integration with Control Systems. The water management system interfaces with the main control architecture to enable:
a. Real-time monitoring of water levels and consumption rates;
b. Predictive maintenance scheduling based on usage patterns;
c. Automated documentation of water addition events; and
d. Integration with humidity control algorithms for optimized performance.

The system maintains a historical log of water levels and refill events, enabling correlation with environmental conditions and experimental outcomes. This data can be used to optimize humidity control strategies and maintenance schedules for specific applications.

Control and Interface Systems. The invention implements a comprehensive and flexible approach to user interaction that advances beyond traditional laboratory instrument interfaces. While existing laboratory automation systems typically rely on limited user interface options-most commonly basic touchscreens or physical buttons-our system introduces multiple innovative interaction paradigms that enhance accessibility, improve operational efficiency, and enable sophisticated remote operations.
a. Local Control Interfaces
   i. Direct Physical Interaction. The system provides traditional yet enhanced physical control mechanisms. A high resolution capacitive touchscreen serves as the primary interface, supporting multi-touch gestures including pinch-to-zoom for detailed data visualization and swipe actions for rapid navigation. Physical control elements include sealed, laboratory-grade buttons for critical functions that may need to be accessed while wearing protective equipment. Haptic feedback mechanisms provide tactile confirmation of user inputs, particularly important in noisy laboratory environments. Precision rotary encoders enable fine adjustment of critical parameters such as temperature and humidity setpoints, providing both rapid gross adjustment and precise fine-tuning capabilities.
   ii. Proximity-Based Interaction. The system implements advanced proximity detection and authentication using multiple complementary technologies. Near-field communication (NFC) capabilities enable rapid user authentication through laboratory ID cards or mobile devices. Bluetooth Low Energy (BLE) beacons provide broader-range proximity detection, enabling automatic system wake-up as authorized users approach. Ultrawideband (UWB) technology enables precise spatial positioning, allowing the system to track authorized devices with centimeter-level accuracy and enabling location-aware interface adaptations. This multi-layered proximity system enables features such as:
      1. Automatic login/logout based on user proximity;
      2. Interface customization based on user location relative to the device;
      3. Secure automatic data transfer to nearby authorized devices;
      4. Location-aware safety interlocks; and
      5. Spatial awareness for multi-unit installations.
   iii. Gesture Recognition Advanced computer vision and infrared sensing technologies enable sophisticated touchless control capabilities. The system employs a combination of 2D and 3D gesture recognition, utilizing:
      1. Infrared depth sensors for precise hand tracking;
      2. Machine learning algorithms for gesture classification;
      3. Temporal gesture pattern recognition; and
      4. Context-aware gesture interpretation.
   iv. This enables users to control the system without physical contact, particularly valuable in clean room environments or when wearing protective equipment. Gesture recognition includes:
      1. Standard gestures for common operations (start/stop, open/close);
      2. Custom gesture programming for user-defined operations;
      3. Two-handed gesture combinations for safety-critical operations; and
      4. Progressive gesture recognition for fine control adjustments.
   v. Voice Control Systems. The system implements advanced natural language processing capabilities optimized for laboratory environments. Multiple beam-forming microphones with noise cancellation enable reliable voice recognition even in noisy laboratory conditions. The voice control system features:
      1. Context-aware command recognition;
      2. Multiple language support with real-time translation;
      3. Voice biometrics for user authentication;
      4. Adaptive noise filtering; and
      5. Custom vocabulary for laboratory-specific terminology.
   vi. Mobile Device Integration. The system implements comprehensive mobile device integration through a sophisticated multi-tiered architecture that extends beyond traditional remote control applications. This integration leverages modern mobile device capabilities while addressing the unique requirements of laboratory environments, including the need for sterile operation and operation while wearing protective equipment.

Native Mobile Applications. The system provides native applications for both iOS and Android platforms, optimized for the specific capabilities of each operating system. These applications implement a layered architecture that separates user interface, business logic, and data management components, enabling robust operation even under varying network conditions. The applications leverage platform-specific features such as Apple's Handoff and Android's Intents system to enable seamless transition between different control interfaces.
a. Key native application features include:
   i. Background monitoring with configurable alert thresholds;
   ii. Local data caching with automatic synchronization;
   iii. Device sensor integration for enhanced functionality; and
   iv. Efficient battery usage through adaptive polling.

The applications implement sophisticated sensor integration capabilities. For example, the device camera can be used for QR code scanning to rapidly configure system parameters or identify samples, while the accelerometer enables gesture-based control when touching the screen is impractical due to protective equipment. The applications also leverage platform-specific security features such as biometric authentication and secure enclaves for credential storage.

Progressive Web Application Implementation. Complementing the native applications, the system provides a progressive web application (PWA) that enables platform independent access while maintaining advanced functionality. The PWA implements modern web standards including Service Workers and Web Storage API to enable offline operation and local data caching. This architecture ensures consistent operation across different devices and browsers while maintaining security and performance.

The PWA employs a responsive design architecture that automatically adapts to different screen sizes and input methods. This adaptation goes beyond simple layout adjustments to include:
a. Interface Optimization. The system dynamically adjusts control element size and spacing based on the device's input characteristics and the user's interaction patterns. For touch interfaces, the system implements sophisticated gesture recognition that accounts for common laboratory scenarios such as gloved operation or indirect interaction through protective barriers.
b. Real-time data synchronization.

Both native and web applications implement a sophisticated data synchronization system that maintains consistency across multiple control interfaces while minimizing network bandwidth usage. This system employs:
a. Differential synchronization algorithms that transmit only changed data;
b. Priority-based synchronization that ensures critical control data is updated first;
c. Conflict resolution mechanisms for simultaneous multi-user access; and
d. Automated recovery from network interruptions.

The synchronization system implements a novel approach to handling intermittent connectivity in laboratory environments. Rather than simply queuing changes for later transmission, the system maintains a state-based model that can reconstruct the complete system state from partial updates, ensuring consistency even when some updates are lost due to network issues.

Security Implementation. Mobile integration includes comprehensive security measures specifically designed for laboratory environments. The system implements a sophisticated certificate-based authentication system ensures secure communication between mobile devices and laboratory equipment. This system supports certificate rotation and revocation, enabling secure operation even in environments where devices may be shared between multiple users.

The implementation includes advanced session management that can detect potential security issues such as unauthorized device movement or unexpected changes in network characteristics, automatically requiring reauthentication when suspicious conditions are detected.

Remote Control Capabilities. The system implements a sophisticated multi-layered network architecture that ensures reliable connectivity across varying laboratory conditions while maintaining security and performance. Primary connectivity is achieved through a Wi-Fi 6 (802.11ax, or legacy Wi-Fi systems) implementation that leverages Multiple User Multiple-Input-Multiple-Output (MU-MIMO) technology, enabling high-bandwidth data transfer even in environments with multiple connected devices.

This advanced wireless implementation allows for simultaneous high-speed connections from multiple control interfaces while maintaining low latency for critical control operations.

The wireless system is complemented by a Gigabit Ethernet backbone that supports Power over Ethernet (PoE), enabling both network connectivity and power delivery through a single cable connection. This dual-purpose connection significantly simplifies installation requirements while providing a reliable, high-speed data path. The PoE implementation follows the IEEE 802.3bt standard, supporting up to 71.3W power delivery, ensuring sufficient power for all system components including peripheral devices.

To ensure continuous operation in varying network conditions, the system implements a sophisticated failover architecture. A dedicated network controller monitors connection quality across all available interfaces, including Wi-Fi, Ethernet, and optional cellular connections. The controller employs a predictive algorithm that analyzes network performance metrics including latency, packet loss, and bandwidth availability to preemptively switch between available networks before performance degradation impacts system operation.

In multi-unit laboratory installations, the system's mesh networking capabilities enable units to form a self-organizing network architecture. Each unit acts as both a network node and potential relay point, creating a resilient communication fabric that can maintain operation even if individual network links fail. This mesh implementation uses the IEEE 802.11s standard with custom extensions for laboratory-specific requirements, including prioritized routing for critical control traffic and secure data encryption.

The networking subsystem implements a sophisticated Quality of Service (QoS) management system that prioritizes critical control traffic over routine data transfer. This QoS implementation uses both standard DiffServ code points (DSCP) for network-level prioritization and application-layer traffic shaping. Critical control messages receive highest priority, followed by monitoring data, with bulk data transfer such as software updates receiving lower priority. This ensures that critical control functions remain responsive even during periods of high network utilization.

For situations where network connectivity may be intermittent, the system implements a sophisticated store-and forward capability. All critical operational data is locally cached using a circular buffer system, with automatic synchronization once network connectivity is restored. This caching system uses a combination of solid-state storage and RAM-based buffers to ensure both rapid access to recent data and long-term storage of historical information.

The system implements a comprehensive cloud and IoT architecture that extends beyond traditional remote monitoring to enable sophisticated distributed control and analysis capabilities. This implementation addresses key challenges in laboratory automation including data security, regulatory compliance, and real-time control requirements while providing unprecedented flexibility in laboratory operations.

Edge Computing Architecture. At the device level, the system implements an advanced edge computing architecture that fundamentally transforms how laboratory equipment processes and responds to data. Unlike traditional cloud-dependent systems, our architecture employs a sophisticated multi-tier processing structure that ensures reliable operation even during network interruptions. The primary edge processor, operating under a real-time operating system (RTOS), maintains critical control loops with sub-millisecond response times, ensuring precise environmental control and system stability. This approach represents a significant advance over conventional cloud-dependent systems by maintaining full operational capabilities even during network outages.

Secondary processors handle data preprocessing and local analytics, implementing sophisticated algorithms that reduce cloud bandwidth requirements while enabling complex local automation. This distributed processing approach enables the system to perform advanced operations such as image analysis and pattern recognition directly at the edge, minimizing latency and reducing dependency on cloud connectivity. The edge computing system maintains a local data buffer that enables continuous operation during cloud disconnections, automatically synchronizing data when connectivity is restored.

IoT Communication Infrastructure. The system's communication infrastructure implements a hybrid protocol approach that optimizes both real-time control and data transfer efficiency. The primary protocol layer utilizes MQTT (Message Queuing Telemetry Transport) for realtime operations, implementing a sophisticated quality of service (QoS) management system that ensures reliable message delivery while optimizing network utilization. This implementation includes advanced features such as topic based message routing and session persistence, enabling efficient data distribution across complex laboratory environments.

For larger data transfers, the system employs HTTP/2 with Protocol Buffers, providing efficient binary data transmission while maintaining compatibility with existing laboratory infrastructure. This dual-protocol approach enables the system to handle both time-critical control operations and large-scale data transfer requirements, such as image and video data from analytical instruments.

Cloud Infrastructure and Laboratory Integration. The cloud infrastructure implements a microservices architecture that represents a significant advance over traditional monolithic laboratory systems. Each service operates independently, enabling flexible scaling and maintenance while maintaining system reliability. The data management service implements a sophisticated time-series database optimization specifically designed for laboratory sensor data, enabling efficient storage and retrieval of experimental parameters while maintaining regulatory compliance.

The laboratory integration hub provides a revolutionary approach to equipment integration, implementing a universal communication layer that enables seamless interaction between diverse laboratory systems. This hub supports multiple integration patterns, from real-time data streaming to asynchronous operations, enabling integration with both modern and legacy laboratory equipment. The system's ability to adapt to different communication protocols and data formats eliminates the traditional barriers to laboratory automation integration.

Security and Regulatory Compliance. The system implements a comprehensive security framework specifically designed for laboratory environments. All data transmission utilizes end-to-end encryption, with encryption keys managed through hardware security modules that provide physical protection for cryptographic operations. This approach ensures data security while maintaining compliance with regulatory requirements such as 21 CFR Part 11 and GDPR.

The compliance system maintains detailed audit trails of all operations, automatically generating documentation that meets GMP requirements. This automated documentation system significantly reduces the administrative burden on laboratory personnel while ensuring consistent compliance with regulatory standards. The system's ability to maintain separate data residency zones enables compliance with regional data protection requirements while maintaining operational efficiency.

A computer, which provides a means interfacing between an operator through a peripheral device, such as a keyboard, touchscreen, voice command, gesture command, or through a digital communication protocol. The computer may be connected to the internet and controlled this way, or controlled using wired peripherals, or a combination thereof.

### Vision System

a. At least one image sensor is included in the invention. In some embodiments, multiple cameras may be used to capture additional light-based data, such as luminescence or fluorescence, thermal imaging, as needed for specific applications. In some embodiments, optical lenses can be included to modulate the zoom and field of view captured by an image sensor. In some embodiments, a linear array may be used to capture light-based signals emitted, reflected, or absorbed by the specimen. In the preferred embodiment, an image sensor is positioned directly above the specimens, but image sensors may be placed at an angle to capture different geometric features of the specimens or to mitigate image distortions or glare. The camera needs to be on a rail and motorized to adjust its position relative to the axis of rotation for the rotating stage, so that we can view into well plates. Also, we can describe a system that is inverted, where the camera is below the Sample holder tray, this inverted configuration may be beneficial for eliminating condensation.
   i. An illumination source may be included in the invention. In the preferred embodiment, the illumination source is mechanically fixed to a rectangular holder that is positioned around a specimen at an angle of <30 degrees relative to the plane of the specimen. This angled illumination minimizes confounding reflections in the image and allows for inspection of specimens that are opaque or highly absorptive of the irradiation electromagnetic radiation. The illumination source may also include a light diffusing medium to create spatially uniform irradiation of the specimen. In other embodiments, the illuminator may be positioned directly beneath the specimen and opposite the camera. In other embodiments, the illumination may be fed using fiber optic cables or light guides from a single light source. In other embodiments, the angular position of the illuminator relative to the specimens may be controlled by a mechanical apparatus (motorized or manually operated) to change the relative angle of illuminating light.
   ii. Optical filters may be included in the invention for performing stimulated fluorescence detection or hyperspectral imaging of specimens. In some embodiments, optical filters (such as acoustic tunable filters, coated optical filters) may be included in the light path between the specimen and the light source to module that wavelength of irradiating light. In some embodiments, optical filters may be included in the light path between the specimen and the image or light sensors such that the wavelength of emitted, scattered, reflected light incident upon the sensor is modulate. Anti reflective filters, polarizing filters, turning mirrors may also be included in the light path to improve image quality and control over the signal-to-noise ratio of low-light signals.
      1. One novel embodiment would be to use an illuminator that has segments that are covered with laminated film to block specific wavelengths of light for excitation of fluorescence. The other idea would be to use a plurality of light guides like fiber optics and an optomechanical filter switch, or optoacoustic light modulator to change the color of excitation light illuminating the specimen.
      2. These film layers can be optical glass or laminated plastics.
   iii. Optomechanical components, optical filters may be controlled using a filter wheel that is positioned over the camera, or linearly actuated optical filter holders. As described above, other light conditioning subsystems like acousto-optic tunable filter and liquid crystal tunable filters may be used to control the wavelength of light in the illumination and imaging light path.

In another embodiment, the invention can be used to obtain both hyperspectral image data sets and superimpose that on visible and fluorescence data sets from the same sample within the same incubator (therefore under identical environmental conditions).

Within the incubator, a motorized rotating sample holder stage moves plates between the visible/fluorescence cameras and the NIR/SWIR (950-1700 nm). In some embodiments, a single camera system can image visible and spectral channels by configuring the illumination lighting or by filtering light that passes to the image sensor. Custom ring illuminators can be controlled by a microcontroller to provide computer-controlled illumination at the appropriate wavelength ranges and timing sequences, as well.

Many camera modules are Original Equipment Manufacturer parts, meaning it is straightforward to physically mount both units onto the incubator enclosure. Black foam gaskets can be cut to size to prevent light and heat leakage where the camera optics are mounted.

The visible and fluorescence illuminator may have at least three addressable LED arrays, for example: white light, 490 ±22 nm to stimulate mNeonGreen fluorescence, and 532 ±35 nm to stimulate mApple fluorescence. The visible and fluorescence imaging system is configured with a motorized filter wheel to allow a plurality of optical filters for fluorescence imaging. For example, a bandpass filter (center wavelength 532 nm; full width half maximum =10 nm) would allow for imaging mNeonGreen, and a long pass optical filter (600 nm cut) for mApple imaging. This setup allows for fluorescence imaging without requiring excitation filters, and thereby allows for uniform illumination over ~100×100 mm area (corresponding to a single Petri dish, for example). A 12.3 mega-pixel color CMOS camera with an 8 mm focal length lens would yield a physical field of view of ~140 mm and a spatial resolution of 43 μm.

The invention may include dedicated spectral imaging systems, wherein the illumination wavelengths do not determine the spectral resolution of the data acquisition process. A SWIR HSI (Specimn GX®, Kinolta® Minolta, Inc.®) captures 168 spectral bands (8 nm resolution) at frame rates up to 800 frames per second, allowing for hypercube data across the entire 950-1700 nm spectrum to be acquired in just a few seconds at full spatial resolution. The Specimn GX has a 38° field of view lens and a 480-pixel image sensor (24.9 μm pixels), such that placing the lens front ~150 mm from the object will provide a 103 mm physical field of view and a spatial resolution of 213 μm. These engineering specifications would yield highly detailed chemical images over an entire 90-mm square Petri dish. A rectangular circuit board with an array of IR LEDs covering the range of approximately 900 to 1700 nm could be used to uniformly illuminate the sample for SWIR HSI acquisition.

In other embodiments, it may be advantageous to reduce data generation complexity and instead incorporate a camera and lens configuration with spectral sensitivity in bandwidths that matter biological. In this approach, light sources, incoherent or coherent, could be adapted with appropriate optics to illuminate specimens in the desired spectral bandwidth depending on target biochemical changes, such as monitoring spatial and temporal changes in chlorophyll (~670-690 nm) or specific monitoring spatial and temporal changes in hydration (1430-1480 nm).

Software development and system calibration. Remote or local access is important to standardize measurement nodes, especially where environmental changes may affect sensor performance over time. As in sample data acquisition, reference materials or calibration hypercubes could be automatically obtained. An external trigger connector on the camera allows for synchronization with the central and remote computer systems to generate hyperspectral image stacks using parameters set by the operator (start wavelength, end wavelength, total number of spectral bands, etc). In this embodiment, an HS imager using reflectivity standards (Spectralon®) could be used to ensure accurate sample illumination and verify system functionality. Or, for example, reference spectra and quantitative models could be obtained by preparing and analyzing agar plates with varying concentrations of key molecules: Carboxymethyl cellulose (CMC; 0.1-2%), cellobiose (0.1-100 mM), and glucose (0.1-100 mM). Additionally, mixture plates containing all three components in various concentrations may be used to simulate complex biological samples.

Prior to statistical analysis, HSI data should undergo a series of pre-processing steps to enhance data quality and interpretability in the preferred embodiment. First, dark current correction can be applied to account for thermal noise, followed by white reference correction using a Spectralon standard to normalize for instrument response and illumination variations. Spectral smoothing can then be performed using a Savitzky-Golay filter. Baseline correction can be implemented using asymmetric least squares to remove effects of scattering and instrument drift. This pre-processing pipeline could ensure that subsequent statistical analyses are performed on high-quality, standardized spectral data, maximizing the potential for detecting and quantifying cellulolytic processes.

The multi-dimensional datasets generated by HSI require advanced statistical analyses for meaningful interpretation. SWIR hypercubes can be analyzed using Multiway Partial Least Squares Discriminant Analysis (N-PLS-DA) to identify key spectral bands that discriminate between bio-and chemical substances. This advanced statistical method generates scores and loadings, for example providing crucial insights into the spatiotemporal dynamics of cellulolytic activity. The scores, representing the projection of each pixel onto new latent variables, can be visualized as pseudocolored images for each significant latent variable at multiple time points. This multi-panel display showcases the progression of cellulolytic activity across the sample over time. High score values indicate a strong presence of the chemical component or biological activity represented by that latent variable, allowing conversion processes to be tracked visually. Loading coefficients, on the other hand, reveal which original spectral bands contribute most to each latent variable. These can be analyzed as line plots, where peaks indicate wavelengths crucial for distinguishing between CMC and its breakdown products. By examining loading coefficients, specific spectral signatures associated with different stages of biological or chemical processes (such as cellulolytic activity) can be identified.

While analyzed separately, scores and loadings are complementary. The scores show where and when changes are occurring in our sample, while the loadings tell what spectral changes are driving those observations. Together, they provide a comprehensive picture of the biological and chemical processes. For example, if a region with high scores for a particular latent variable is observed in the hypercube image space, it is possible to refer to the corresponding loadings to understand which chemical changes (as indicated by specific spectral bands) are responsible for that observation. Moreover, identifying key wavelengths through loading analysis can help optimize future SWIR imaging protocols, potentially allowing for faster or more targeted data collection. The application of multiway analysis techniques, particularly N-PLS-DA, to hyperspectral imaging data of temporal microbial, insect, or plant processes (such as cellulolytic processes) builds upon research in related fields such as satellite imaging of mining or agricultural operations, albeit at a much smaller but still critical scale of biology and chemistry.

The invention implements a sophisticated optical analysis system that enables multiple imaging modalities while maintaining flexibility for various specimen types and experimental requirements. This system advances beyond traditional imaging approaches through several key innovations in sensor deployment, illumination design, and optical filtering.

Image Sensor Configuration. The system's primary imaging capability centers on at least one high-resolution image sensor, with provisions for multiple sensor implementations to address specific analytical requirements. In the preferred embodiment, the primary image sensor is positioned directly above the specimens, mounted on a motorized rail system that enables precise positioning relative to the rotating stage's axis. This motorized positioning system provides critical flexibility for imaging different vessel types, particularly when examining specimens in well plates where angle and distance adjustments are essential for proper visualization.

The system supports multiple sensor configurations to address varying analytical needs:
a. Standard brightfield imaging for morphological analysis;
b. Fluorescence detection for tagged specimen visualization;
c. Thermal imaging for temperature distribution analysis; and
d. Linear array sensors for specialized spectral analysis.

An innovative inverted configuration option positions the camera below the sample holder tray, providing several advantages including condensation elimination and improved optical access for certain specimen types. This configuration particularly benefits long-term studies where condensation on vessel lids can interfere with image quality.

In certain embodiments, the system comprises both an upper imaging assembly positioned above the sample holder tray and a lower imaging assembly positioned below the sample holder tray, configured to enable simultaneous image acquisition of biological specimens from opposing optical axes. To support this dual-imaging configuration, the sample holder tray is fabricated from a material that is optically transparent across one or more defined wavelength ranges, such that illumination or emitted light from a specimen is transmissible through the tray body to the lower imaging assembly. In one embodiment, the tray material is transparent across the visible spectrum, enabling brightfield or color imaging from below. In another embodiment, the tray material is selected for transparency in the near-infrared or short-wave infrared range while remaining opaque in the visible spectrum, enabling spectrally selective imaging modalities to be assigned independently to the upper and lower cameras. In certain embodiments, the tray may incorporate discrete optically transparent windows or zones aligned with each sample position, with the surrounding tray body remaining opaque, so as to minimize stray light transmission between adjacent sample positions during simultaneous dual-axis imaging. The upper and lower imaging assemblies may be configured to acquire images simultaneously or in a defined temporal sequence synchronized by the control electronics. Simultaneous acquisition from opposing axes enables the system to capture complementary information from a single specimen in a single imaging event—for example, the upper camera acquiring colony surface morphology under reflected visible illumination while the lower camera acquires transmitted infrared data representing the biochemical composition of the culture medium or the colony interior. In some embodiments, the illumination sources associated with the upper and lower imaging assemblies may be spectrally distinct, allowing each camera to image under its own dedicated illumination condition without optical cross-talk between the two channels

Illumination System. The illumination system implements several novel approaches to specimen illumination that overcome limitations in existing systems. In the preferred embodiment, the primary illumination source is mechanically fixed to a rectangular holder and positioned at an angle of less than 30 degrees relative to the specimen plane. This carefully chosen angle represents a significant advance over traditional top-down illumination by:
a. Minimizing confounding reflections that can interfere with image analysis;
b. Enabling effective inspection of opaque or highly absorptive specimens; and
c. Providing enhanced contrast for surface feature detection.

The illumination system incorporates several innovative features:
a. Light Distribution Control. The system employs specialized diffusing media to create uniform specimen illumination, essential for quantitative analysis. This diffusion system adaptively controls light distribution based on specimen characteristics and imaging requirements.
b. Multiple Illumination Modes. The system supports various illumination configurations including:
   i. Angular illumination from multiple positions around the specimen;
   ii. Sub-stage illumination for transparent specimens;
   iii. Fiber optic delivery systems for precise light placement; and
   iv. Motorized angular adjustment for optimized contrast.

Illumination Angle Configuration. The invention implements a critical innovation in specimen illumination through precise control of illumination angles. In the preferred embodiment, the illumination source is mechanically fixed to a rectangular holder and positioned at an angle of less than 30 degrees relative to the plane of the specimen. This specific angular configuration represents a crucial advance over conventional top-down illumination systems for several reasons.

First, this shallow angle of incidence (less than 30 degrees from the specimen plane) minimizes specular reflections that typically interfere with image acquisition and analysis. When illumination sources are positioned at larger angles, particularly in the range of 45-90 degrees, reflections from specimen vessels, culture media, or the specimens themselves can create artifacts that compromise image quality and complicate automated analysis.

Second, this angular configuration enables effective inspection of specimens that are opaque or highly absorptive of the incident electromagnetic radiation. The shallow angle increases the effective path length through translucent specimens, enhancing contrast and revealing subtle features that might be missed with traditional illumination geometries. This is particularly important for:
a. Colony morphology assessment;
b. Surface texture analysis;
c. Detection of subtle color variations; and
d. Examination of biofilm formation,

The mechanical mounting system allows for precise adjustment of this angle, with calibrated positions ensuring reproducible illumination conditions. The rectangular holder provides stable positioning while allowing for potential rotation around the specimen axis, enabling:
a. Multi-angle illumination for enhanced feature detection;
b. Shadow reduction through multiple light source positions;
c. Uniform illumination across larger specimen areas; and
d. Compensation for specimen vessel geometry.

This angular configuration works in concert with the diffusing elements and optical conditioning systems to create highly uniform illumination while maintaining the critical angle relationships that minimize interfering reflections.

Advanced Wavelength Selection and Light Delivery Systems. The invention implements several sophisticated approaches to wavelength-selective illumination, enabling precise control over excitation and emission spectra for various imaging modalities. These implementations represent significant advances over traditional filter-based systems by providing greater flexibility and control while maintaining cost effectiveness.

Monochromator-Based Illumination System. The primary configuration utilizes a broadband light source coupled to a monochromator, enabling precise wavelength selection across a continuous spectrum. This system provides several key advantages over discrete filter-based approaches.

Light Delivery Configuration. The monochromator output is coupled to the specimen illumination system through multiple possible paths.

Guided Light Delivery. The system employs liquid light guides or fiber optic bundles to route spectrally filtered light to specific positions within the enclosure. This implementation includes:
a. Multiple output ports for simultaneous multi-point illumination;
b. Specialized coupling optics to maximize light transmission;
c. Flexible positioning systems for optimal sample illumination; and
d. Integration of light spreading elements at guide terminations.

The output of these light guides incorporates specialized diffusing elements that transform the inherently directional output into uniform illumination patterns. These elements are designed to:
a. Maintain spectral integrity across the illuminated area;
b. Provide consistent intensity distribution;
c. Minimize light loss while maximizing uniformity; and
d. Enable rapid switching between illumination patterns.

Free-Space Propagation. In an alternative configuration, the monochromator output propagates through free space, with the source positioned at a calculated distance from the specimen plane. This arrangement:
a. Eliminates transmission losses associated with light guides;
b. Provides inherently uniform illumination through beam divergence;
c. Reduces system complexity and maintenance requirements; and
d. Enables rapid wavelength scanning without mechanical delays.

Discrete Source Implementation. The system also supports implementation using discrete light sources, providing complementary capabilities to the monochromator-based approach.

LED Array Configuration. The system implements an advanced LED array architecture that provides precise spectral control while maintaining cost effectiveness and operational reliability. The array consists of multiple LED elements, each optimized for specific wavelength bands corresponding to commonly used fluorophores in biological research. This wavelength optimization is achieved through both careful semiconductor selection and advanced phosphor coating technologies, enabling precise spectral matching to excitation requirements for fluorescent proteins such as GFP, RFP, and their variants.

Individual intensity control is implemented through a sophisticated pulse-width modulation system operating at frequencies above 20 kHz to prevent interference with image acquisition. Each LED channel incorporates dedicated constant-current drivers with 12-bit resolution, enabling fine adjustment of illumination intensity while maintaining spectral stability. This precise control allows for complex illumination sequences, such as sequential excitation for multicolor fluorescence imaging or ratio-metric measurements.

The LED control system maintains strict synchronization with the image acquisition subsystem through a dedicated timing controller. This controller manages both the LED switching and camera exposure timing with sub-microsecond precision, essential for applications such as time-resolved fluorescence measurements or high-speed multi-channel imaging. The system can generate complex illumination patterns, including rapid sequential switching between wavelengths or simultaneous multi-wavelength excitation with independently controlled intensities.

Temperature management, critical for maintaining consistent LED spectral characteristics, is achieved through an active thermal control system. Each LED array incorporates temperature sensors and a dedicated thermal management system that maintains operating temperature within ±0.1°C. This thermal stability ensures consistent spectral output and prevents wavelength drift that could otherwise compromise measurement accuracy. The thermal management system includes both passive heat sinking and active temperature control elements, with thermal feedback maintaining optimal operating conditions across extended operating periods.

The LED array's physical configuration is optimized for uniform sample illumination, with careful attention to light distribution patterns. Specialized secondary optics, including total internal reflection (TIR) lenses and holographic diffusers, ensure even illumination across the sample area while maintaining high optical efficiency. This optical design minimizes spectral variations across the field of view while maximizing light delivery to the sample.

Laser Integration. For applications requiring exceptional spectral purity or high-intensity illumination, the system implements sophisticated laser-based illumination capabilities. This integration addresses specific challenges in fluorescence excitation, confocal imaging, and high-speed analysis that cannot be adequately addressed by conventional LED or broadband sources.

Laser Source Implementation. The system primarily utilizes semiconductor diode lasers selected for their compact size, long operational lifetime, and precise wavelength control. These sources are specifically chosen to match common fluorophore excitation requirements, with typical wavelengths including 405 nm, 488 nm, 532 nm, and 635 nm. Each laser module incorporates individual temperature control through thermoelectric cooling elements and precision current regulation, ensuring wavelength stability better than ±0.1 nm and power stability of ±0.5% over extended operation periods.

Beam Conditioning and Uniformity. A critical challenge in laser-based illumination is achieving uniform sample illumination while maintaining the advantages of laser coherence. The system addresses this through a sophisticated beam shaping approach. The initial laser output passes through a multi-element beam expansion system that precisely controls the beam diameter and divergence. This expanded beam then encounters a specialized diffusive optical element that transforms the Gaussian intensity profile into a uniform “top-hat” distribution. Critical to this transformation is the use of engineered diffusers that maintain high transmission efficiency (>85%) while achieving uniformity variation of less than ±5% across the illumination field.

Speckle Reduction Technology. Laser speckle, a consequence of coherent illumination, can significantly degrade image quality in many applications. The system implements multiple complementary approaches to speckle reduction. A primary vibrating optical element introduces phase diversity on timescales shorter than the camera exposure time. This is complemented by a rotating diffuser that provides additional spatial phase averaging. The combination of these techniques typically achieves speckle contrast reduction to less than 1% while maintaining illumination uniformity. The mechanical elements of these systems are carefully isolated to prevent vibration transmission to the specimen stage.

Power Monitoring and Control. The system incorporates sophisticated real-time power monitoring and stabilization features essential for quantitative measurements. A beam sampling arrangement using a precision beam splitter directs a small portion (typically 1%) of the laser output to a calibrated photodiode detector. This feedback signal drives a proportional-integral-derivative (PID) control loop that adjusts the laser drive current to maintain constant output power. The control system achieves power stability better than ±0.1% over typical imaging timeframes, essential for quantitative fluorescence measurements.

Integration with Imaging System. The laser illumination system is fully integrated with the imaging and environmental control systems. Electronic shuttering, synchronized with camera exposure timing, prevents unnecessary sample exposure and potential photobleaching. The control system enables sophisticated illumination sequences, including rapid switching between different laser wavelengths for multi-color imaging applications, with switching times typically less than 1 ms. Power levels can be independently controlled for each wavelength, enabling optimization for different fluorophores or experimental requirements while maintaining sample viability.

Illumination Control and Integration. The wavelength selection system interfaces with the main control system to enable:
a. Automated wavelength scanning for hyperspectral imaging;
b. Synchronization with filter wheels and liquid crystal filters;
c. Integration with exposure timing for fluorescence lifetime measurements; and
d. Dynamic adjustment based on sample characteristics.

This comprehensive approach to wavelength selection and light delivery enables:
a. Hyperspectral imaging across continuous wavelength ranges;
b. Multispectral imaging at discrete wavelength bands;
c. Fluorescence excitation optimization; and
d. Automated spectral scanning protocols.

The system's flexibility in illumination configuration represents a significant advance over existing systems, enabling adaptation to various experimental requirements while maintaining ease of use and reliability.

Alternative Stage Rotation Methods. While direct drive and gear-based systems provide one approach to stage rotation, the invention also implements an innovative belt and pulley system for transferring rotational force from a non-coaxial motor to the rotating stage. This configuration offers several distinct advantages in both mechanical design and operational performance.

The belt-drive implementation utilizes precision timing belts and matched pulleys to ensure accurate position control while minimizing mechanical backlash. By positioning the motor off-axis, this arrangement enables more flexible motor placement for optimal space utilization within the enclosure. This configuration significantly reduces heat transfer from the motor to temperature-sensitive specimens, a critical consideration for maintaining precise environmental control.

The non-coaxial arrangement also facilitates simplified motor maintenance and replacement without requiring complete system disassembly.

The system can be implemented using several belt types, each offering specific advantages for different operational requirements. Toothed timing belts provide the highest positioning accuracy and are preferred for applications requiring precise specimen positioning. Flat belts with crown pulleys offer exceptionally smooth operation with minimal vibration transmission, while Poly-V belts enable increased power transmission for heavier load applications. For extended lifetime in high-duty-cycle applications, reinforced belts incorporating aramid or steel cord tensile members ensure reliable operation while maintaining positioning accuracy.

Motor positioning flexibility represents a key advantage of this design. The motor can be mounted with vertical offset to reduce the overall enclosure footprint, or with horizontal offset to accommodate other subsystems such as environmental controls or imaging components. The angular positioning can be optimized to achieve ideal belt wrap angles, enhancing power transmission efficiency and reducing belt wear. In complex installations, multiple belt stages can be implemented to route power transfer around other system components while maintaining precise motion control.

The belt tension system incorporates mechanical design elements to ensure reliable operation. Spring-loaded tensioner mechanisms maintain consistent belt tension while accommodating thermal expansion and normal wear. Precision adjustment capability enables fine-tuning of system performance, while anti-vibration mounting reduces mechanical noise transmission to sensitive specimens. The system includes belt wear compensation features that maintain optimal performance over extended periods, and the inherent compliance of the belt drive enables rapid deceleration for emergency stop conditions without risking mechanical damage.

This configuration particularly benefits applications requiring precise temperature control near the specimen area, as the motor's heat generation can be physically separated from sensitive samples. The design also minimizes electromagnetic interference from motors, which can be crucial for sensitive imaging applications. The system enables regular motor maintenance without requiring complete system disassembly, and the belt-pulley ratio can be easily modified to achieve different speed reduction options. Additionally, the inherent damping characteristics of the belt drive system result in notably quieter operation compared to direct drive or gear-based solutions.

Yet another way to move the stage would involve the use of rotating magnets, which mounted on the stage would interact with either stationary set of phase-shifted electromagnetics or magnetic pulley that, without physical contact, can drive the rotation of nearby magnets mounted on the stage.

Primary Magnetic Drive Configuration. In the primary implementation, permanent magnets are securely mounted to the rotating stage in a circular array. These magnets interact with a sophisticated electromagnetic drive system positioned beneath the stage. The electromagnetic drive consists of multiple phase-shifted coils that, when energized in sequence, create a rotating magnetic field. This field couples with the permanent magnets on the stage, inducing controlled rotation without physical contact. The system's electronic control enables precise speed and position control through careful modulation of the electromagnetic field strength and rotation rate. “Contact free” electromagnetic actuations could be in a curved or even linear configuration to exert sufficient force tangential to the surface of the rotating stage.

The permanent magnets are selected for high magnetic field strength and temperature stability, typically utilizing rare earth materials such as neodymium-iron-boron (NdFeB) with appropriate surface treatments to prevent corrosion. These magnets are arranged in a carefully optimized pattern that maximizes coupling strength while maintaining smooth rotation characteristics.

Alternative Magnetic Pulley Implementation. An alternative configuration employs a magnetic pulley system where permanent magnets mounted on a motor-driven pulley interact with corresponding magnets on the stage. This arrangement creates a magnetic gear-like coupling that transfers rotational force without physical contact. The spacing between the drive pulley and stage magnets is precisely maintained through careful mechanical design, enabling efficient power transfer while preventing physical interference.

Control and Position Sensing. The magnetic drive system incorporates sophisticated position sensing and control mechanisms. Hall effect sensors positioned near the rotating stage detect the passage of the permanent magnets, providing precise feedback for position control. This feedback enables both accurate speed control and precise positioning of specimens for imaging or manipulation.

Advanced Features and Advantages. The magnetic drive system offers several unique advantages for laboratory automation. The contactless nature of the drive eliminates the need for lubricants that could potentially contaminate specimens. The system maintains sterility requirements more easily than traditional mechanical drives, as there are no physical connections between the drive system and the specimen chamber.

The system's electronic control enables sophisticated motion profiles, including smooth acceleration and deceleration curves that minimize specimen disturbance. The absence of mechanical wear components significantly reduces maintenance requirements and extends system lifetime. Additionally, the magnetic drive can operate effectively through non-magnetic barriers, enabling complete isolation of the specimen chamber from the drive mechanisms.

Sample Access and External Integration Systems. Existing laboratory automation systems typically implement rudimentary approaches to sample access that compromise environmental control and specimen integrity. For example, U.S. Pat. No. 8,092,695(2012 ) describes a basic colony picking system that requires complete chamber opening for access, while U.S. Pat. No. 7,865,008(2011 ) employs simple pick-and-place mechanisms that disrupt environmental conditions during transfers. Neither system addresses the fundamental challenge of maintaining precise environmental control during automated access operations.

Traditional incubator systems, such as those described in U.S. Pat. No. 9,434,937 (2016), typically employ single-door access methods that expose the entire chamber to ambient conditions during sample retrieval. These systems lack any means for maintaining local environmental control or creating graduated environmental transitions during access operations. Furthermore, existing systems fail to provide the precise position registration and multiple access modalities required for sophisticated laboratory automation integration.

Novel Access Implementations. The present invention overcomes these limitations through several innovative approaches to automated sample access, each designed to maintain environmental stability while enabling precise sample handling.

Motorized Tray System. Unlike conventional systems that employ simple sliding trays or static sample holders, our system implements a sophisticated motorized tray mechanism that maintains both positional accuracy and environmental control. The entire rotating stage assembly, including its position encoding system and drive mechanisms, is mounted on a precision linear rail system driven by a ball-screw mechanism. This configuration represents a significant advance over existing systems by enabling:

Coordinated Motion Control. The system maintains precise synchronization between rotational and linear movements through:
a. Absolute position encoding in both rotation and extension axes;
b. Real-time position feedback with ±0.1 mm accuracy;
c. Sophisticated motion profiles that prevent sample disturbance; and
d. Continuous position registration during all movements.

This level of motion control precision exceeds capabilities found in existing systems, which typically employ simple stepper motor drives without position feedback or coordination between axes.

Environmental Management. Unlike traditional systems that accept complete environmental exposure during access, our system implements:
a. A novel rolling seal mechanism that maintains isolation during extension;
b. Multiple independent environmental control zones;
c. Real-time monitoring and adjustment of conditions; and
d. Predictive environmental control algorithms.

Alternative Access Implementations. The system introduces two novel approaches to sample access that fundamentally advance beyond existing technologies.

Motorized Door System. While conventional systems typically employ simple hinged or sliding doors, our implementation introduces:
a. Multi-layer door construction with sophisticated thermal management;
b. Precision servo control with position feedback;
c. Local environmental control zones around access points; and
d. Rapid environmental recovery capabilities.

Magnetic Door System. This innovative approach eliminates mechanical penetrations through the environmental barrier, a significant advance over traditional mechanical door systems. Key features include:
a. Electromagnetic locking mechanisms;
b. Magnetically-coupled drive systems;
c. No direct mechanical linkages through chamber walls; and
d. Fail-safe operation capabilities.

Environmental Zone Control. The system implements a sophisticated approach to environmental management that goes beyond the simple global control found in existing systems. Our zone control system creates multiple independently regulated environmental regions that enable:
a. Graduated environmental transitions during access;
b. Localized condition maintenance around access points;
c. Minimal disruption to non-accessed specimens; and
d. Rapid recovery of optimal conditions.

This multi-zone approach represents a fundamental advance over traditional single-zone environmental control systems, enabling maintenance of precise conditions even during access operations.

Integration Capabilities. The system's integration capabilities extend beyond simple handshaking protocols found in existing systems to include:
a. Real-time status reporting and environmental monitoring;
b. Sophisticated error handling and recovery procedures;
c. Flexible communication protocols for multi-vendor integration; and
d. Comprehensive logging and verification systems.

The optical access features of the Sample Holder enable several advanced imaging configurations that extend beyond traditional top-down imaging approaches. When implemented with transparent regions, the holder facilitates sophisticated multi-modal imaging through careful consideration of materials and optical properties.

Trans-illumination Methods. The system supports both upright and inverted microscopy configurations through strategically designed optical windows. The transparent regions are manufactured from laboratory-grade borosilicate glass or optical-quality polycarbonate, providing excellent transmission characteristics across visible and near-IR wavelengths. These materials maintain their optical properties during repeated sterilization procedures and exposure to common laboratory chemicals. The optical windows are precision-mounted with specific consideration for maintaining parallel surfaces and minimizing mechanical stress that could induce birefringence.

Enhanced Detection Capabilities. The optical surfaces incorporate multi-layer anti-reflection coatings optimized for the 350-800 nm spectral range, reducing reflection losses to less than 0.5% per surface. These coatings maintain their performance under laboratory conditions and cleaning procedures. For applications requiring maximum light collection efficiency, such as low-light fluorescence imaging, the holder can be configured with enhanced reflective surfaces surrounding the optical windows. These surfaces utilize protected silver coatings to provide >98% reflectivity across the visible spectrum, significantly improving collection efficiency for emitted light.

Mechanical Integration. The optical windows are integrated into the holder using a precision mounting system that maintains alignment during rotation while preventing mechanical stress on the optical elements.

Specialized elastomer gaskets provide both mechanical isolation and light-tight seals around each optical window. The mounting system accommodates thermal expansion differences between the optical elements and the main holder structure, ensuring consistent performance across the operating temperature range.

Environmental Considerations. The optical windows include thermal management features to prevent condensation that could interfere with imaging. This is achieved through strategic placement of small heating elements around the optical windows and careful thermal isolation from the main specimen chamber. The system maintains optical window temperature slightly above the internal chamber temperature, effectively preventing condensation without disturbing specimen temperature.

Illumination Control and Integration. The system implements a sophisticated control architecture that coordinates multiple optical and electronic subsystems to enable advanced spectral imaging capabilities. This integration is achieved through a hierarchical control system that manages timing, synchronization, and data acquisition across various hardware components.

Wavelength Scanning Implementation for hyperspectral imaging of biological samples. The hyperspectral imaging capability is enabled through precise coordination between the wavelength selection system and image acquisition components. In monochromator-based configurations, a stepper motor controller interfaces with both the wavelength drive mechanism and the camera system through a dedicated timing controller. This controller generates precisely timed trigger signals that coordinate:
a. Wavelength Selection. The system employs a high-precision stepper motor with micro-stepping capability (typically 25,000 steps per revolution) to control the monochromator grating position. A closed-loop encoder system provides position feedback with 0.1 nm wavelength accuracy. The controller implements acceleration/deceleration profiles to minimize mechanical vibration during wavelength changes.
b. Exposure Timing. Camera exposure periods are synchronized with wavelength stability periods through hardware trigger signals. The controller ensures that image acquisition only occurs after mechanical settling time (typically 50-100 ms) and required intensity stabilization period at each wavelength position.
c. A mechanical shutter can be included on the broadband source to regulate when the illumination is shown onto the samples.

If reflected, fluorescent, or transmitted light is filtered, an electromechanical wheel or linear slide can be used to position various types of optical filters between the sample and the image sensor.

To achieve hyperspectral imaging analysis within this invention, liquid crystal tunable filters (LCTFs), the system provides precise electronic control of wavelength selection:

A dedicated driver supplies accurately controlled voltages to the liquid crystal elements, enabling rapid wavelength switching (<50 ms). The controller maintains:
a. Temperature compensation for wavelength stability;
b. Calibrated voltage-wavelength relationships;
c. Sequential or random-access wavelength selection; and
d. Polarization state management.

Fluorescence Lifetime Integration. For fluorescence lifetime measurements, the system implements precise temporal control over both excitation and detection.

The timing controller generates multiple synchronized signals controlling:
a. Excitation source modulation (laser or LED) with sub-microsecond precision;
b. Camera gain modulation for phase-sensitive detection;
c. Time-gated detection windows with programmable delays; and
d. Multi-pulse averaging for improved signal-to-noise ratio.

Data Acquisition and Processing. The control system incorporates a high-speed data acquisition subsystem that:
a. Captures and buffers image data at each wavelength position;
b. Associates wavelength/filter metadata with each image;
c. Performs real-time intensity corrections; and
d. Manages data storage and transfer to host system.

The system provides a comprehensive API enabling:
a. Custom scanning sequence definition;
b. Real-time data access and analysis;
c. Integration with external triggering systems; and
d. Automated calibration and validation procedures.

This integrated control architecture enables complex measurement sequences while maintaining precise timing relationships between optical, mechanical, and electronic subsystems. The system's modular design allows for future expansion and adaptation to new measurement requirements.

Coaxial Fiber-Based Illumination Configuration. The system implements an innovative coaxial illumination approach utilizing fiber optic delivery systems to achieve highly uniform specimen illumination while maintaining perfect alignment with the imaging axis. This configuration employs a precision optomechanical assembly that combines illumination and imaging paths through a common optical axis.

The primary illumination path begins at a fiber port interface, where light from various sources (broadband, LED, or laser) is coupled into a multi-mode optical fiber optimized for the desired wavelength range. The fiber output is collimated using an achromatic lens system that minimizes chromatic aberration across the operational spectral range. This collimated beam enters a specialized coaxial illuminator assembly that includes:
a. A precision-mounted beamsplitter cube positioned at 45 degrees to both the illumination and imaging paths.
b. The beamsplitter's coating is optimized for the specific application, typically providing 50:50 splitting for brightfield imaging or dichroic properties for fluorescence applications.
c. A series of relay lenses that maintain beam collimation while enabling adjustment of the illumination field diameter. These lenses are anti-reflection coated to minimize losses and prevent stray reflections that could degrade image quality.

The coaxial arrangement provides several critical advantages:
a. Perfectly centered illumination relative to the imaging field of view;
b. Elimination of shadowing effects common in off-axis illumination;
c. Consistent illumination angle across the entire field; and
d. Simplified alignment and maintenance procedures.

The system incorporates additional optical elements to enhance illumination uniformity:
a. Field stops to control illumination area;
b. Diffusing elements to eliminate fiber mode patterns;
c. Apodizing filters to smooth beam intensity profiles; and
d. Telecentric lens arrangements to maintain illumination geometry across varying working distances.

This coaxial fiber-based system integrates with the main control architecture through:
a. Motorized field stop adjustment;
b. Computer-controlled fiber coupling for multiple light sources;
c. Automated alignment verification procedures; and
d. Real-time intensity monitoring and adjustment.

As used throughout this application, the singular forms “a”, “an” and “the” include plural forms unless the content clearly dictates otherwise. In addition, the term “or” is generally employed in its sense including “and/or” unless the content clearly dictates otherwise.

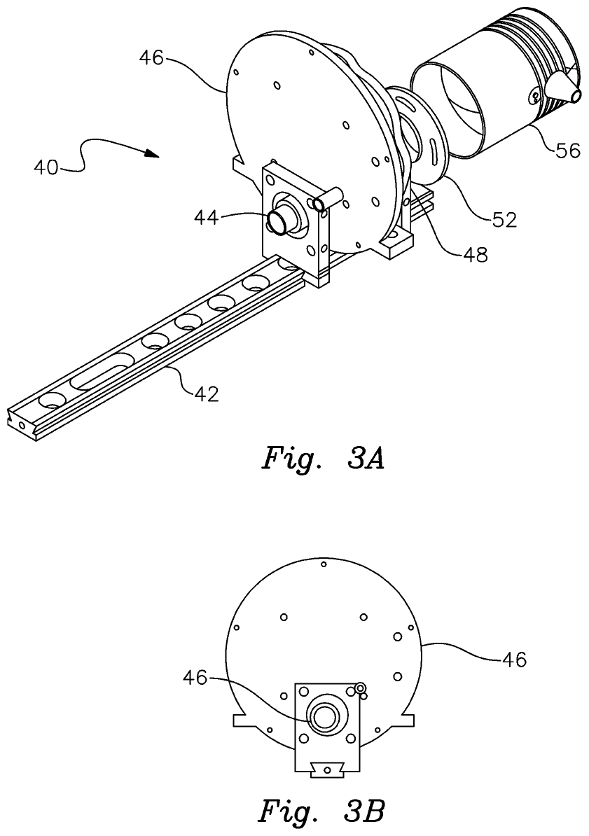

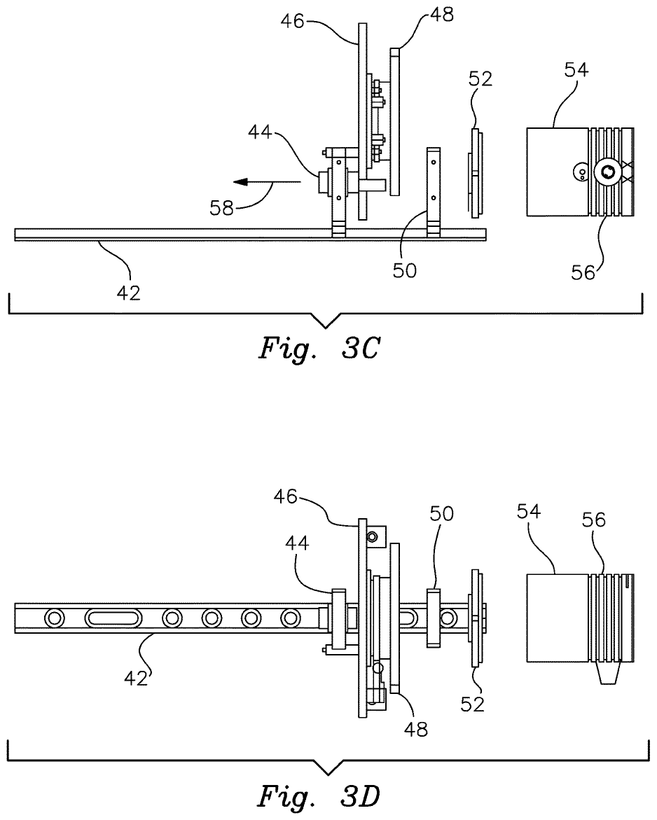

FIGS. 3A-D illustrate light modulating assembly 40 configured to generate and condition illumination light 58 for imaging a biological sample. The assembly includes optical rail 42, which provides a rigid, linear support structure for aligning optical components along a defined optical axis. Optical rail 42 may include standardized mounting features to enable modular configuration and interchangeability of optical elements.

Beam shaping option 44 is mounted along optical rail 42 and is configured to modify one or more properties of illumination light 58, including spatial distribution, divergence, and intensity profile. Beam shaping option 44 may include lenses, diffusers, apertures, or programmable optical elements.

Mechanical mounts 46 support optical components and maintain alignment within the assembly. Mechanical mounts 46 may include adjustable positioning mechanisms to enable fine alignment of optical components relative to the optical axis.

Bandpass filter slide or wheel 48 is positioned along the optical path and is configured to selectively filter illumination light 58 based on wavelength. Bandpass filter slide or wheel 48 may include multiple filters corresponding to discrete spectral bands.

Sliding mounts 50 enable controlled insertion or removal of bandpass filter slide or wheel 48 or other optical components into the optical path. This configuration enables dynamic switching between illumination conditions, thereby allowing selective observation of different biological features or fluorescence responses.

Adapter 52 provides mechanical and optical coupling between the filter system and downstream optical elements. Collimating optics 54 are configured to convert divergent light from an illumination source into a collimated beam directed toward the sample. Illumination source 56 may include a lamp, LED array, or fiber-coupled light source, and is configured to provide illumination light 58 to the optical system.

In operation, light modulating assembly 40 generates illumination light 58, conditions the light through beam shaping option 44 and bandpass filter slide 48, and directs the conditioned light via collimating optics 54 toward a biological sample. The ability to dynamically adjust illumination parameters enables enhanced imaging contrast and selective detection of biological features.

In certain embodiments, the imaging system incorporates a telecentric lens configured to eliminate parallax error during imaging of specimens contained in multi-well plates or other vessels having significant depth relative to their aperture. In a conventional lens system, the chief rays converge toward the lens at varying angles across the field of view, causing features at different depths within a well to appear at different lateral positions and apparent sizes—an effect that becomes particularly pronounced when imaging the full array of a 96-well or 384-well plate where the outermost wells are imaged at an oblique angle relative to the optical axis. A telecentric lens addresses this by positioning the aperture stop at the front focal plane of the system, maintaining the chief rays parallel to the optical axis across the entire field of view. This ensures that the apparent position, size, and shape of features within each well remain consistent regardless of their depth within the vessel, enabling accurate quantitative comparisons of biological features across all wells in a single imaging frame. In some embodiments, the telecentric lens may be mounted on an interchangeable motorized holder, such as a filter wheel or linear actuator, allowing the system to switch between a standard lens configuration for petri dish imaging and a telecentric configuration for well plate imaging without requiring manual optical reconfiguration by the operator.

Phosphorescent imaging may be accomplished by using the computer system or other electrical subsystems to temporally control the illumination and image acquisition sequence. For example, the illuminator can be set to maximum brightness for a duration of time per the requirements of the measurement, and then shut off. At that moment the image acquisition process will commence, where the exposure time is configured per the requirements of the measurement.

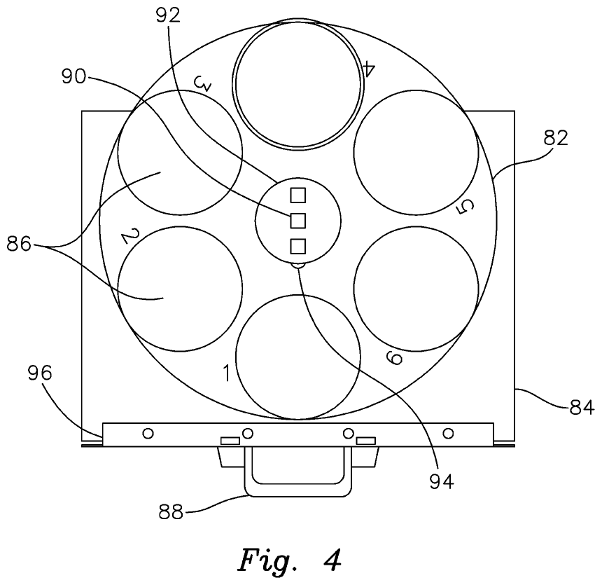

FIG. 4 illustrates a sample handling system configured to position biological samples for imaging and analysis. The system includes rotating sample holder 82 disposed within tray 84. Rotating sample holder 82 includes a plurality of petri dish sample holders 86, each configured to receive a biological sample, such as a petri dish.

Rotating sample holder 82 is supported by bearing housing 92, which enables rotational movement of the sample holder. Rotation may be controlled to sequentially position individual samples within a field of view of an imaging system. This enables automated imaging of multiple samples without manual repositioning.

Tray 84 may be removably inserted into a housing and may include handle 88 to facilitate handling. In certain embodiments, magnets 90 may be used to secure tray 84 and enable rapid interchangeability of sample trays. Key and lock alignment mechanism 94 ensures repeatable positioning of rotating sample holder 82 relative to the imaging system. Front door or wall 96 may enclose the sample handling system to protect samples and maintain controlled environmental conditions.

Functionally, the sample handling system enables high-throughput imaging workflows by coordinating sample positioning with illumination and imaging systems. Rotating sample holder 82 may be synchronized with imaging acquisition to capture images of each sample in sequence.

Vessels that contain specimens are secured onto a physical Specimen Holder, which in the preferred embodiment is a flat and circular shaped tray that has indentations that match the shape of commonly used vessels. For example, indentations may be circles that are 90-mm in diameter to hold a glass or plastic Petri dish. Indentations may also be rectangular to accommodate a standard 96 well plate. Indentations may also be optically clear or provide an optical window to allow for transmission of light through the specimen. In this case, a physical lip, groove, or spring-activated holder may be used to secure the specimen vessel in place on the Specimen Holder. In some embodiments, the indentation may be 1-5 mm in depth, and will have a solid and opaque bottom. In other embodiments, the solid bottom may be reflective to maximize the intensity of light emitted from the specimen to improve fluorescence, luminescence, phosphorescence detection sensitivity.

The circular Sample Holder has at its central axis a bearing mounted within a plastic housing that is keyed. The key allows for proper alignment and for rotational force to be transferred between the Holder and the bearing. The bearing is physically mounted to a stationary shaft that is secured to a rectangular plate. A wall is physically attached to the rectangular plate at a right angle to form another wall, such that when the assembly (Sample Holder and rectangular plate) is slid into the physical enclosure fully, the wall completes the enclosure and minimizes air and light exchange between the internal compartment and the environment.

The Sample Holder may have protrusions, like the teeth of gears, that interlock with a pinion mounted on a rotating motor when the tray is positioned within the incubator enclosure. The gear “teeth” may be on the bottom of the rotating stage, on the top surface, or within the side. In some embodiments, rotation of specimens may be accomplished instead by magnetism, wherein magnetic materials are embedded or attached to the sample holding tray and magnets are also embedded or attached to the motor spindle. In other embodiments, the Sample Holder itself may be secured coaxially to the rotor of the motor.

One or more surfaces of the Sample Holder may include markings that interact with a Position Sensor or Positioning software within the invention. The purpose of this is to provide feedback to the operator and to the control software to track each unique specimen.

There are numerous ways to automate the control of sample positions within this invention. For example, a shape may be imprinted, cut out, taped on, or engraved onto the surface of the tray so that the computer vision system can detect the position of the specimen within the field of view and provide feedback to the motor to stop rotating the Specimen Holder. In the preferred embodiment, at least one reflective stripe is painted onto the surface of the Specimen Holder. A light emitter and light detector (e.g., a light emitting diode and photodiode) are positioned beneath the Specimen Holder and oriented such that emitted light is reflected by the stripe is directed to the light sensor.

This physical encoding system provides a simple yet effective means to capture consistently aligned images over long periods of time with low-cost control actuators and sensors.

In one embodiment, more than one sensing device (two or more emitter/detector pairs) are used to provide additional positioning information for the control system and operator. For example, a Specimen Holder tray having six indentations on its top surface to accommodate circular Petri dishes may have six reflective stripes, one of which is longer in the radial dimension that the other five to denote a “home” or “initial” position. This example could be extended to encode more or fewer positions, as needed for different applications. The reflective stripes are very narrow (approximately one millimeter wide) to provide a high degree of spatial resolution for the positioning sub-system.

Two or more position sensing devices may be positioned at different polar or radial coordinates relative to the axis of rotation of the Specimen Holder.

In other embodiments, Hall effect sensors, tunneling magnetoresistive, or inductive sensors can be used in place of light-based position sensors. In other embodiments, a mechanical mechanism may be used, such as a pressure transducer positioned between the Specimen Holder that detects physical contact with a protruding attachment, like a small bump attached to the Specimen Holder.

In certain embodiments, the sample holder tray and the stationary background tray beneath the rotating stage incorporate a plurality of visual registration features configured to enable computer vision-guided autonomous positioning of both the rotating stage and the imaging system. These registration features may include markings, embossed patterns, stamped patterns, or printed geometric shapes of defined colors, sizes, and spatial arrangements applied to one or more surfaces of the tray. The computer vision system continuously monitors the positions of these features within the camera's field of view and generates feedback signals used to control both the rotational position of the sample holder and the radial position of the camera along its motorized rail. By correlating the detected registration features against a stored reference map of the tray geometry, the control system can autonomously drive the rotating stage to place a specific sample within the imaging field of view and simultaneously adjust the radial position of the camera to center on a particular well, colony, or region of interest within that sample. In this manner, the registration features serve as a coordinate reference system that enables closed-loop, computer vision-guided positioning of both the sample and the imaging system without requiring manual alignment by the operator. The shapes, colors, and spatial arrangement of the registration features may be selected to maximize detection reliability under the illumination conditions present within the enclosure, and may further encode positional metadata such as sample identity, tray orientation, or home position reference. The sample tray may also include a gasket and optically clear cover that is secured such that a compartment is formed around all or some of the specimens to minimize or block gas transport. In this embodiment, a sachet containing chemical catalysts may be placed within the sealed compartment to consume oxygen and generate a hypoxic or anaerobic atmosphere conducive to growth for some organisms.

Data Analysis Processes and Methods. In today's scientific environment, large quantities of information are typically siloed within organizational units. Even trivial information like camera settings for proper image acquisition is difficult to obtain without trial and error, reviewing handwritten or digitized lab notes from colleagues within the same organization, or reviewing published methods, for example in scientific journals, from other scientists and technicians working in other organizations. Finding and then applying this information is a lengthy and often manual endeavor and is not in a format that can be readily applied either digitally or through analog electrical signals to easily set up and execute an imaging experiment with current technologies and performing image-based analysis with currently available methods.

The difficulty of obtaining information extends far beyond executing reproducible scientific procedures—it greatly hampers progress toward scientific insight and discoveries. This invention provides additional methods and apparatuses for both communicating and leveraging scientific and operational information more effectively and faster, without human intervention and human biases, and other limitations such as fatigue, distractions, and errors. For example, it is possible with the present invention to predict the required analysis steps for specific biological and chemical tests and thereby achieve greater high-throughput and more easily drawn scientific conclusions.

By integrating user input (keyboard, mouse, touchscreen, spoken instructions captured by microphone, gestures), existing data sets in the system, data stored in systems belonging to collaborating organizations, public information published in online databases, or in scientific journals and search engines, methods are disclosed herein to incorporate these information sets and make predictions about the biological and chemical processes and thereby facilitate laboratory workflow (less hands-on time for the scientists), but also to infer probable outcomes from specific assays and make suggestions to the scientist to accelerate their analysis efforts.

For example, once the sample tray is placed into the “closed” position (detected by a physical switch or by monitoring the video feed from the camera), the system can capture image frames or apply a series of morphological and other image filters to digitally process text information, recognize the specimen vessel (a circular petri dish or a rectangular single well plate), and detect other physical information such the color of the medium, handwriting on the sample vessel, barcodes/QR codes/stickers, and with these data the invention would predict the required camera settings for specific imaging procedures:

Image acquisition settings that might be predicted would include gain, lens focus point, shutter time, timing of image acquisition, synchronization with illumination sources.

Image analysis steps, such as cropping, annotation, object detection, and based on input information from user and automatically detected information. These same data points collected from the system would be used to recommend time settings for the experiment and would prompt a search (automatically in the digital domain or by guiding the operator) to access public databases or the databases of other invention users that have permitted shared access, to apply additional image/video analysis tools to detect unique features might be of interest to the scientist.

For example, if the user prompts the machine that they are analyzing E. coli that expresses green fluorescent protein (GFP) in the presence of a specific antibiotic, and the data from the imaging indicates that the GFP signal is weaker than expected based on data from other users that also harness GFP expression in E. coli as a reporter for specific biochemical pathway activation, then the data analysis process may provide links to published data on ways to improve expression, or the data analysis workflow may suggest that the pathway is not activated properly and that a different medium should be used, and it could display a list of new media that are available or used. The data analysis process may access third-party tools such as generative AI systems to create a suggested annotation for the experimental results, and also display data from earlier experiments or from shared databases within the Mira network of users to provide comparative analyses. In these ways, the data analysis workflow can accelerate scientific discovery incorporating image data (within one organization or between multiple organizations) and cross-reference information also provided by the users such as the type of organism, the color of the colonies, the experimental parameters such as the specific genes that are mutated or inserted, the so-called reporter molecule, the contents of the growth medium, all pieces of information can be brought together to teach the data analysis methods and accelerate comparative tests that would otherwise require manual intervention by a highly-skilled human operator.

The present invention provides specific methods and apparatuses to easily acquire, integrate, and synthesize more than just visual information, it would incorporate written, spoken, imported images, imported laboratory information management system data, electronic laboratory notes, project management information, so-called multi-omic data (genomic, epigenomic, transcriptomic, proteomic, and meta-omic data), clinical or operational data to make predictions of the types of experiments that should be executed, and in what order or propose an experimental framework for interrogating biological activity. For example, working through the mechanism of drug resistance for a specific fungus, the method would incorporate the objective, make recommendations of growth media, image acquisition parameters, data analysis steps, provide an electronic means for acquiring those materials using an automatically generated hyperlink to online search engine results. It would also make suggestions to avoid redundant experimentation by providing both electronic display or written text or audio feedback through speakers connected to the system to advise operators to try a different experimental procedure by examining the current input settings and comparing those settings to historical records in the current user's database and in the databases of other users connected to the network or from data in the public domain.

Here is an example of how this method and process and apparatus would work together. A user has prepared six 90-mm Petri dishes, three with lysogeny broth agar (LB) and three with eosin methylene blue (EMB) agar. When the sample holder tray is pulled out, a few different sensors may prompt specific actions by the system: a limit switch positioned between the sample tray door and the framing of the system would initiate a Start Up process, or the camera system would detect that the sample tray has been pulled out to the loading position by measuring optical flow in the camera's field of view or by some other computer vision algorithm for detecting motion, or in another embodiment a position sensor placed between the ring illuminator and central area of the sample tray holder. Or the user could prompt the Start Up process via a touchscreen or a similar peripheral device, or the user could speak specific words such as “Hello Mira”, for example, or “Mira let's start an experiment on Machine A1” to specify which unit the user wishes to control when multiple inventions are present within audible range of the user.

As the user loads each plate into the different labeled sample holder positions, they have the option to type the name of each sample or they can speak the names of the samples, as prompted by an audio or visual cue, and the system will record that information digitally. Similarly, the type of agar and the intended assay name may also be typed or spoken during or after the time of sample labeling. The user may also decide to enter the name of the organism that is being interrogated in accordance with naming standards (for example, genus, species and strain). In a simplified example, the system would use the agar type and/or the assay name to query a digital database and/or a public or a shared database (for example, the database from a collaborating university laboratory) via the web, or an intranet service, or an telecommunication network internal to the user's organization to make a recommendation on the camera settings, incubation times, temperature settings for each sample. The user need not speak or enter the name of the media—the camera system may also deduce from the visual characteristics of the culture media (color/reflectivity) what the camera settings range should be and provide that recommendation.

Additional information could be provided through the audio output of the system, or written text, or sent by electronic mail or text message to the user, or shared via a web-application that is linked to the user's registered account and their physical system, or by way of a chat window within the web-browser (i.e. a web-browser plug-in), or through a so-called desktop or mobile software application. This additional information could be, for example, a list of hyperlinks or names of publications that interrogated the stated organism in a similar way. The additional information may also be recommended products that are needed for similar types of assays, such as hyperlinks to petri dish vendors, or pre-made culture media vendors.

In this specific example, as microbial colonies grow and become visible by the camera system, additional information can be extracted from the characteristics of the colonies such as their color, morphology, size, and the color of the surrounding culture media, that would allow the system to deduce additional information about the specimen and provide additional information to the users-for example if a colony forms on one of the EMB plates that is dark blue-black with a metallic green sheen, the camera system may suggest to the user using one or more ways of communicating stated just above that the colony may be E. coli or a related microbial species. Additional information could be provided such as recommended techniques for genotyping the colony, such as accessing public databases like NCBI GenBank and querying common genetic codes for PCR primers. Similarly, the system could query a generative AI software system for recommendations on techniques to further identify the colony (also called the isolate) and display those techniques through the communication channels described above. These recommended techniques could be filtered by user input, so that the system learns what techniques are of interest to the user and their research plan or analytical needs. These filters could be applied prior to the start of the experiment too, and can be updated using a variety of software systems.

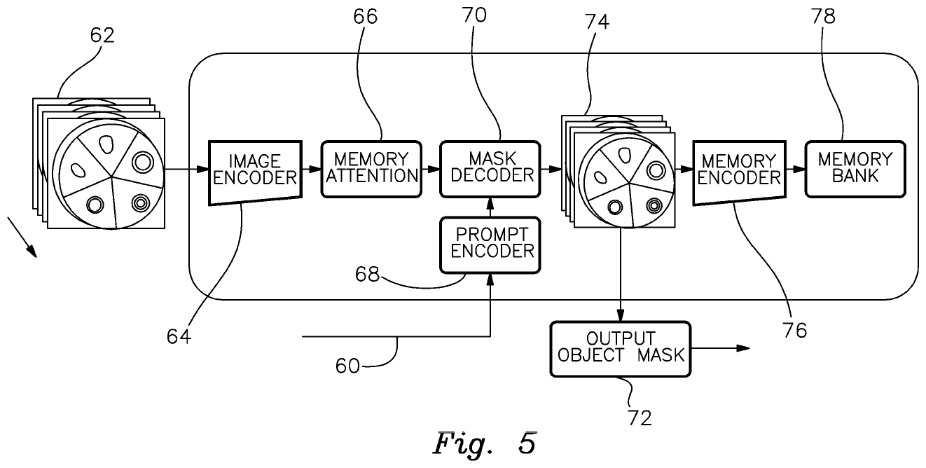

Turning now to FIG. 5 there is shown a Distributed Phenotypic Surveillance and Decision System flow chart. FIG. 5 illustrates an image processing architecture configured to analyze images of biological samples. Petri dish 62 containing a biological sample is imaged to produce input image data, which is processed by image encoder 64. Image encoder 64 extracts feature representations from the input images. User input point 60 may be employed as well. Memory attention module 66 processes encoded image features and integrates contextual information from memory encoder 76 and memory bank 78. Memory encoder 76 encodes historical or reference data, and memory bank 78 stores such data for retrieval and comparison.

Prompt encoder 68 may receive user input or task-specific instructions and encode them into representations used to guide analysis. Mask decoder 70 integrates information from image encoder 64, memory attention module 66, and prompt encoder 68 to generate segmentation outputs.

Output object mask 72 represents identified biological features, such as colonies, cells, or regions of interest. Intermediate representations 74 may be used during processing to refine segmentation or classification results.

Light modulating assembly 30, sample handling system (FIG. 4), and image processing architecture (FIG. 5) may be operatively connected to form an integrated imaging and analysis system. Light modulating assembly 30 provides controlled illumination tailored to the biological sample. The sample handling system positions samples for imaging, while the image processing system analyzes captured images to extract biological features.

In certain embodiments, outputs from the image processing system may be used to adjust illumination parameters of light modulating assembly 30 or positioning parameters of the sample handling system. This feedback loop enables adaptive imaging, where imaging conditions are dynamically optimized based on observed sample characteristics

In alternative embodiments, light modulating assembly 30 may include tunable filters, programmable light sources, or adaptive optics. The sample handling system may include robotic arms, conveyor systems, or microfluidic devices. The image processing system may incorporate deep learning models, transformer architectures, or distributed computing systems.

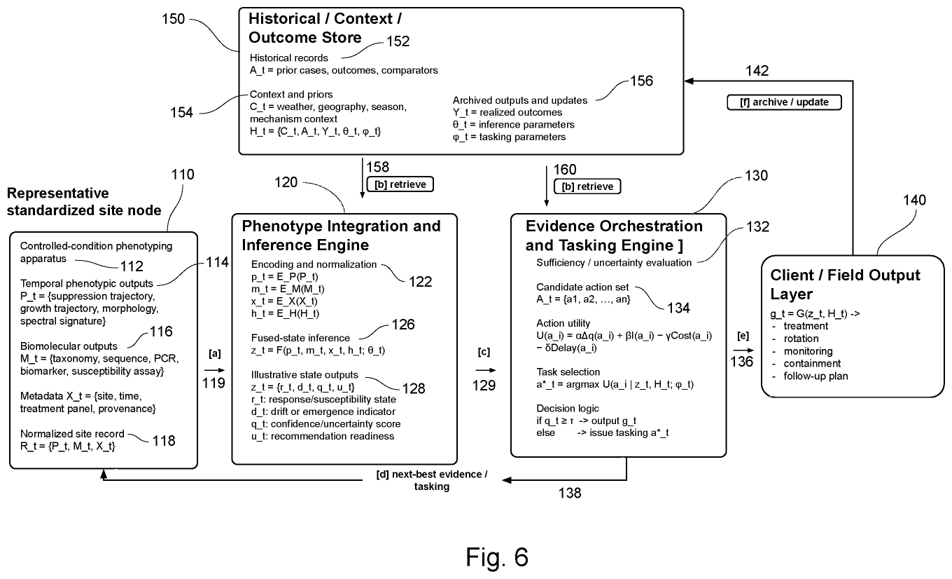

FIG. 6 illustrates an example architecture of an automated experimental orchestration and inference system configured to analyze biological observations, integrate heterogeneous measurement data, and generate recommended experimental actions. The system shown in FIG. 5 forms a closed-loop experimental decision architecture in which biological observations are collected, interpreted through computational inference models, and used to guide subsequent investigative or experimental actions.

In the illustrated embodiment, the architecture includes representative standardized site node 110, phenotype integration and inference engine 120, evidence orchestration and tasking engine 130, client or field output layer 140, and historical or context store 150. Communication between these modules may occur over wired or wireless network interfaces and may be implemented using distributed computing systems, cloud-based infrastructure, or local computing resources.

Representative standardized site node 110 is configured to collect biological observations from a monitored biological system. In certain embodiments, the site node may represent a laboratory instrument, environmental monitoring station, agricultural field sensor array, or other experimental data acquisition platform.

At step 112, controlled-condition phenotyping may be performed. Controlled-condition phenotyping may include imaging of biological specimens, monitoring microbial colony development, observing plant growth, monitoring insect populations, or other biological measurement activities. In some embodiments, the phenotyping may occur under controlled laboratory conditions such as regulated temperature, humidity, nutrient composition, and lighting conditions.

Step 114 represents a temporal or spatial phenotyping trajectory. In this stage, observations of biological features may be recorded across multiple time points or spatial sampling locations. For example, sequential images may capture colony growth patterns, morphological changes in cells, plant phenotypes, or insect behaviors across time.

Step 116 represents biomolecular or biochemical outputs obtained from the biological sample. These outputs may include genetic sequencing results, polymerase chain reaction (PCR) assays, immunoassays, biochemical measurements, or other molecular analysis outputs.

The collected information may then be aggregated at step 118 to produce a normalized site record. In certain embodiments, the normalized site record may represent a structured data object combining imaging data, molecular measurements, and contextual metadata. The normalized record may be expressed conceptually as R_t=f(I_t, M_t, X_t), where I_t represents imaging measurements, M_t represents molecular measurements, and X_t represents contextual metadata associated with the observation.

Normalized site record 118 may then be transmitted through interface 119 to phenotype integration and inference engine 120.

The phenotype integration and inference engine 120 is configured to integrate observations from the standardized site node and infer underlying biological states.

At step 122, encoding and normalization operations may transform incoming site data into structured feature representations suitable for computational analysis. These operations may include normalization of imaging signals, feature extraction from image data, encoding of molecular measurements, and transformation of contextual metadata.

Step 126 represents a fused state inference process. In this process, probabilistic inference models or machine learning algorithms combine information from multiple measurement modalities to estimate latent biological states. For example, imaging-derived features, molecular measurements, and contextual variables may be integrated to estimate biological conditions such as infection status, stress response, metabolic activity, or phenotypic classification.

The inference engine may produce state outputs at step 128. The state outputs may include predicted classifications, inferred biological states, probability distributions, uncertainty estimates, or other analytical results representing the inferred condition of the biological system.

Outputs from the inference engine 120 may be provided to the evidence orchestration and tasking engine 130. This engine coordinates decision-making processes that determine whether further data collection, testing, or intervention is required.

At step 132, the system may evaluate sufficiency and uncertainty of the available evidence. The system may determine whether the available data are sufficient to support a reliable conclusion regarding the biological condition being evaluated.

Step 134 represents action utility evaluation. In this stage, the system may evaluate candidate actions A={a1, a2, . . . an}. Candidate actions may include additional testing, follow-up sampling, laboratory assays, containment procedures, treatment steps, or monitoring activities. The evaluation may consider factors such as expected information gain, cost of action, risk mitigation, and resource availability.

Based on this evaluation, the engine may select a next action or task and generate tasking outputs at step 136.

Client or field output layer 140 represents systems or personnel responsible for executing the recommended actions generated by the orchestration engine. For example, the client layer may correspond to laboratory operators, automated laboratory instruments, agricultural field management systems, or biosecurity response teams.

Actions transmitted to the client layer may include recommended treatments, additional laboratory assays, containment instructions, or monitoring procedures. In some embodiments, the client layer may include automated systems capable of executing these actions without human intervention.

The steps labeled [a] through [f] in FIG. 6 represent discrete action points in the experimental orchestration loop at which either human or automated intervention is valid. Specifically, step [a] at site node 110 represents data collection and normalization, which may be performed by automated laboratory instrumentation or, alternatively, by a human operator who manually acquires samples, records observations, or enters metadata through an input interface. Step [b], corresponding to retrieval pathways 158 and 160 from historical or context store 150, may be triggered automatically by the inference or orchestration engines, or initiated by a human operator querying the historical record. Step [c] at interface 129 between phenotype integration and inference engine 120 and evidence orchestration and tasking engine 130 represents transmission of inferred state outputs, which may occur autonomously or following human review and approval of the inferred biological state before further processing. Step [d], the next-best evidence or tasking pathway 138 returning to site node 110, may be executed by automated laboratory instruments acting on issued tasks, or may constitute instructions presented to a human operator who then performs the recommended intervention, data collection or assay manually. Step [e] at output 136 from the evidence orchestration and tasking engine to client or field output layer 140 represents recommended actions, which may be transmitted to automated robotic systems for execution or displayed to a human operator or field team for manual implementation. Step [f], corresponding to archive update pathway 142, may be performed automatically upon completion of an experimental cycle or may require human confirmation before outcomes and inference parameters are committed to historical or context store 150. In this manner, each step in the claimed method is compatible with human execution, machine execution, or a combination thereof, and the system is designed to accommodate varying degrees of automation without departing from the scope of the claimed invention.

The architecture may further include historical or context store 150. The historical store maintains archived records of prior experimental observations, outcomes, and contextual information.

At step 152, the store may contain historical records including prior experimental results, model outputs, and contextual observations. At step 154, contextual priors may include geographic context, seasonal patterns, environmental conditions, or historical biological patterns. Archived outputs and updates may be stored at step 156. In certain embodiments, archive update pathway 142 allows the system to update the historical store with new observations and outcomes generated by the experimental system.

Information stored in the historical context store 150 may be retrieved through retrieval pathways 158 and 160 by the phenotype integration and inference engine 120 or the evidence orchestration and tasking engine 130. Such contextual information may improve inference accuracy and guide decision-making.

The architecture illustrated in FIG. 6 supports iterative feedback and learning. Feedback pathways 138 allow evidence obtained from testing or additional measurements to be returned to the inference engine and orchestration engine. Through repeated cycles of observation, inference, and action selection, the system may continuously refine its models and decision logic.

In alternative embodiments, representative site node 110 may include distributed sensing platforms deployed across multiple geographic locations. In such embodiments, observations from multiple sites may be aggregated by phenotype integration and inference engine 120 to support large-scale monitoring and analysis.

In some embodiments, phenotype integration and inference engine 120 may incorporate deep learning models, probabilistic graphical models, or hybrid machine learning architectures capable of integrating heterogeneous biological data types.

In further embodiments, evidence orchestration and tasking engine 130 may implement reinforcement learning or Bayesian decision frameworks to optimize experimental strategies over time.

In some implementations, client or field output layer 140 may include robotic laboratory systems configured to automatically perform recommended experiments, thereby forming a fully autonomous experimental platform.

It will be appreciated that the modules illustrated in FIG. 6 may be implemented using hardware, software, or combinations thereof. The functional elements described herein may be executed by processors, specialized accelerators, or distributed computing systems.

The system architecture may be implemented as a centralized platform or as a distributed system spanning multiple computing nodes. The particular arrangement of modules illustrated in FIG. 6 represents one example configuration and should not be interpreted as limiting.

Various modifications and variations may be made without departing from the scope of the disclosed systems and methods. Accordingly, the embodiments described in connection with FIG. 6 are intended to be illustrative rather than limiting.

While the invention has been described in connection with preferred embodiments, it is not intended to limit the scope of the invention to the particular form set forth, but on the contrary, it is intended to cover such alternatives, modifications, and equivalents as may be included within the spirit and scope of the invention as defined by the later issued claims.

1. A self-driving laboratory system for autonomous analysis of biological and chemical samples, comprising:
a. a plurality of automated laboratory instruments configured to perform biological or chemical measurement operations for distributed acquisition of time-stamped and geo-tagged imaging data across the instruments and the instrument sites over a period of time;
b. a plurality of sensors configured to generate test measurements associated with the operations with integration of image data with experimental metadata, historical results, and external networked knowledge sources;
c. a computing system comprising one or more processors and memory storing instructions for analysis directed to specific biological and chemical analysis and intervention objectives; and
d. a computing system comprising one or more processors and memory storing instructions that, when executed, cause the computing system to: analyze the integrated data representation; generate one or more classifications, recommendations, or next-step measurement guidance based on the analysis; and transmit the generated guidance to at least one of the automated laboratory instruments or to an operator interface.

2. The system of claim 1, wherein the artificial intelligence optimization engine is configured to generate a recommendation for a subsequent imaging condition, sampling condition, or analysis condition based on an estimated biological state determined from image data and associated metadata.

3. The system of claim 1, further comprising generating experimental protocols for interpreting textual biological and chemical analysis objectives using a natural language processing model trained on scientific literature, laboratory protocols, contextual metadata, regional environmental conditions, and historical biological and chemical measurements results.

4. The system of claim 1, wherein the sensors comprise at least one selected from the group comprising imaging sensors, optical lenses, spectroscopic sensors, environmental sensors, or biochemical assay instruments.

5. The system of claim 1, wherein the computing system is configured to perform multi-modal sensor fusion to combine measurements from multiple sensors into a unified estimate of experimental state.

6. The system of claim 1, further comprising computer vision models configured to analyze biological image data together with environmental and operational metadata.

7. The system of claim 1, wherein the system dynamically modifies environmental parameters including temperature, pH, nutrient concentration, or gas composition during execution of an experiment.

8. The system of claim 2, wherein the artificial intelligence optimization engine performs multi-objective optimization across a plurality of experimental performance metrics.

9. The system of claim 1, further comprising a distributed learning network configured to share experimental models between multiple instrument sites.

10. A networked computer-implemented method for autonomous laboratory experimentation of biological samples, comprising: receiving an analysis objective describing a target outcome; translating the objective into testing variables; generating candidate measurement protocols using an optimization model; executing at least one protocol using automated instrumentation having a plurality of cameras and sensors; collecting measurements from one or more of the sensors; integrating the measurements to estimate a biological state; updating the optimization model based on the estimated state; and generating one or more subsequent e protocols configured to improve the target outcome.

11. The method of claim 10, wherein generating the experimental protocols comprises probabilistic sampling of an analysis parameter space.

12. The method of claim 10, wherein estimating the biological state comprises combining multiple sensor measurements using a statistical state estimation model.

13. The method of claim 10, further comprising dynamically adjusting imaging acquisition parameters during a measurement based on observed biological changes like antimicrobial or anti-pest efficacy or to match changes in host behavior or phenotype.

14. The method of claim 10, wherein updating the optimization model comprises transfer learning using results from prior measurements.

15. An automated biological imaging device, comprising:
a. a housing configured to receive a plurality of biological samples on a rotating tray;
b. an imaging system comprising at least one optical sensor configured to capture images of the biological samples;
c. one or more illumination sources configured to illuminate the biological samples for a defined period of time;
d. a motion control system configured to position the biological samples on the tray relative to the imaging system; and
e. a computing system comprising one or more processors and memory storing instructions, wherein the computing system is configured to:
i. control the imaging system to capture images of the biological sample;
ii. process the captured images to extract one or more biological features associated with the sample;
iii. determine one or more imaging parameters based on the extracted biological features; and
iv. automatically adjust at least one imaging parameter to capture subsequent images of the biological sample.

16. The device of claim 15, wherein the imaging system comprises a microscope camera configured to capture brightfield, fluorescence, or hyperspectral images.

17. The device of claim 15, wherein the motion control system comprises a motorized stage configured to scan multiple fields of view across the biological sample.

18. The device of claim 15, wherein the computing system executes a computer vision model configured to identify phenotypic and time-changing features of cells, microbes, spores, plant tissue, or insects.

19. The device of claim 15, wherein the computing system dynamically adjusts imaging frequency based on detected biological changes in the sample.

20. The device of claim 15, wherein the imaging system comprises a first optical sensor positioned above the sample holder tray and a second optical sensor positioned below the sample holder tray, and wherein the sample holder tray is optically transparent in at least one defined wavelength range such that the first and second optical sensors are configured to simultaneously acquire images of a biological specimen from opposing optical axes.
